(19) United States
(12) Patent Application Publication
(10) Pub. No.: US 2010/0225985 A1
(43) Pub. Date: Sep. 9, 2010

(54) REPRODUCING DEVICE AND REPRODUCING METHOD

(75) Inventors: Atsushi Fukumoto, Kanagawa (JP); Kenji Tanaka, Tokyo (JP); Masaaki Hara, Tokyo (JP); Akio Yamakawa, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/697,639

(22) Filed: Feb. 1, 2010

(30) Foreign Application Priority Data
Mar. 6, 2009 (JP) 2009-053200

(51) Int. Cl. G03H 1/22

(52) U.S. Cl. 359/32

(57) ABSTRACT

A reproducing device including a light source that emits light for reproducing recorded information to a hologram recording medium subjected to recording of information by interference fringes of signal light and reference light, a light irradiating unit that generates the reference light for obtaining a reproduced image according to the recorded information and DC light having uniform intensity and phase, and irradiates the hologram recording medium with both the reference light and the DC light and with only the DC light, a light receiving unit that performs light-reception for the DC light and the reproduced image, and performs light-reception for the DC light, and a difference calculating unit that calculates a difference between an image signal obtained based on a light-reception result of the reproduced image and the DC light, and an image signal obtained based on a light-reception result of the DC light.

### BACKGROUND OF THE INVENTION

1. Field of the Invention

The present invention relates to a reproducing device and a method thereof for performing reproduction of a hologram recording medium.

2. Description of the Related Art

For example, as disclosed in Japanese Unexamined Patent Application Publication Nos. 2006-107663, 2008-152827, and 2008-310924, there is known a hologram recording and reproducing method which records data by using the interference fringes of signal light and reference light, and reproduces the data recorded by using the interference fringes by using irradiation of the reference light. As the hologram recording and reproducing method, there is known a so-called coaxial method that performs recording by arranging the signal light and the reference light on a same axis.

### [High Density Recording by Phase Modulation Recording]

FIGS. 17, 18A and 18B are diagrams for illustrating techniques of hologram recording and reproduction by the coaxial method, and FIG. 17 shows a recording technique and FIGS. 18A and 18B show a reproducing technique.

First, in FIG. 17, incident light from a light source is subjected to spatial light intensity modulation (hereinafter, simply referred to as “intensity modulation”) in a spatial light modulator (SLM) 101 during recording, and thereby, signal light and reference light arranged on a same optical axis are generated as shown in the drawings. The SLM 101, for example, is constituted with a crystal liquid panel or the like.

At that point, the signal light is generated by being subjected to intensity modulation according to recorded data in a pixel unit. In addition, the reference light is generated by subjecting intensity modulation by a predetermined pattern.

The signal light and reference light generated in the SLM 101 as above are subjected to spatial-phase modulation by a phase mask 102. As shown in the drawings, a phase pattern is randomly assigned for the signal light and reference light by the phase mask 102.

The reason for randomly assigning a phase modulation pattern for the signal light and reference light is because a DC component can be suppressed and high density recording can be achieved by promoting enhanced interference efficiency of the signal light and reference light and expanding the spectrum of recording signals.

In that case, a random phase pattern by two values, for example, of “0” and “π” may be set as a phase modulation pattern. In other words, a phase modulation pattern may be set, half of which includes pixels not subjected to phase modulation (that is, phase=0) and another half of which include pixels subjected to phase modulation by π (180°).

Here, as signal light, the SLM 101 generates light the intensity of which is modulated to “0” or “1” according to recorded data with intensity modulation. When such signal light is subjected to phase modulation by “0” or “π”, light is generated respectively having “−1”, “0”, and “1(+1)” as wave-front amplitude. In other words, when a pixel modulated with the light intensity “1” is subjected to modulation of phase “0”, the amplitude is “1”, and when subjected to modulation of phase “π”, the amplitude is “−1”. In addition, a pixel of light intensity “0” has the amplitude “0” regardless of the modulation of the phase “0” or the phase “π”.

Here, the signal light is generated by being subjected to the intensity modulation according to the recorded data. For that reason, the light intensity (amplitude) “0” and “1” are not randomly arranged at all times, but promote the generation of the DC component.

The phase pattern by the phase mask 102 is assumed to be a random pattern. Accordingly, it is possible to randomly divide (in half) pixels having the light intensity “1” in the signal light and the reference light emitted from the SLM 101 into the amplitude “1” and “−1”. As such, by randomly dividing into the amplitude “1” and “−1”, it is possible to uniformly scatter the spectrum on Fourier plane (frequency plane: in this case, it may be deemed as an image on a medium), and thereby suppressing the DC component generated by a recording signal.

If the DC component is suppressed as above, it is possible to enhance data recording intensity.

Here, due to the generation of the DC component in the recording signal, the recording materials show drastic response due to the DC component and multiple recording of a hologram may not be achieved. In other words, a portion where a DC component is recorded may not be subjected to further multiple recording of a hologram (or data).

If a DC component is suppressed by a random phase pattern as above, it is possible to perform multiple recording of data and to achieve high density recording.

Let us go back to the explanation.

The signal light and reference light subjected to the phase modulation by the phase mask 102 are condensed together by the objective lens 103 and irradiated onto a hologram recording medium HM. Accordingly, interference fringes (diffraction grating: hologram) are formed according to the signal light (recorded image) on the hologram recording medium HM. In other words, due to the formation of the interference fringes, the recording of data can be performed.

Here, as can be understood by the explanation above, in a hologram recording and reproducing system, a unit of data recorded by one interference of signal light and reference light is a minimum unit of recording and reproduction. In signal light, data of “0” and “1” are 2-dimensionally arranged by spatial light modulation of the SLM 101. In other words, the signal light carries information equivalent to a plurality of bits of recorded data. In the hologram recording and reproducing system, a unit of data equivalent to the plurality of bits arranged in the signal light as above is a minimum unit of recording and reproduction. Moreover, a hologram recorded by one interference of the signal light and the reference light is called a “hologram page” in that the hologram includes the plurality of data bits as mentioned above.

For the next in FIGS. 18A and 18B, reference light is generated by the spatial light modulation (intensity modulation) of the SLM 101 for incident light during reproduction as shown in FIG. 18A. Furthermore, the reference light generated as above is assigned with the same phase pattern as in recording by the spatial light phase modulation by the phase mask 102.

In FIG. 18A, the reference light subjected to the phase modulation by the phase mask 102 is irradiated onto the hologram recording medium HM via the objective lens 103.

Accordingly, at this point, the reference light is assigned with the same phase pattern as in the recording. Such reference light is irradiated onto the hologram recording medium HM, and thereby diffracted light is obtained according to a recorded hologram, and the diffracted light is emitted from the hologram recording medium HM as reflected light, as shown in FIG. 18B. In other words, a reproduced image (reproduced light) can be obtained according to recorded data.

The reproduced image obtained as above is subjected to light-reception in an image sensor 104 constituted with, for example, a charge coupled device (CCD) sensor, a complementary metal oxide semiconductor (CMOS) sensor, or the like, and reproduction of recorded data is performed based on the light receiving signal of the image sensor 104.

### [High Density Recording by an Aperture]

In the technique of the hologram recording and reproducing described above, it is possible to achieve the high density recording by using the phase mask 102 to suppress the DC component of the signal light. Such a technique using the phase mask 102 is regarded as having achieved the high density recording as the technique enables multiple recording of a hologram page.

On the other hand, in related art, there was suggested a technique of reducing the size of a hologram page, as another approach to attaining the high density recording.

Specifically, as shown in the next FIG. 19, an aperture 105 is provided so that signal light (and reference light) irradiated onto the hologram recording medium HM during recording is incident, and only light within a predetermined range from the center of an optical axis of the signal light is transmitted by the aperture 105. The aperture 105 is provided in a position that corresponds to Fourier plane (in other words, a frequency plane conjugated with a surface of a medium for recording a hologram page).

As such, it is possible to reduce the size of a hologram page recorded onto the hologram recording medium HM by the aperture 105 provided on the Fourier plane, and as a result, it is possible to achieve the high density recording in that an area taken up by each hologram page on a medium is reduced.

When employing the technique of achieving the high density recording by using the aperture 105, as a transmission region in the aperture 105 gets small, it is possible to reduce the size of a hologram page, and to achieve further high density recording. However, narrowing the transmission region as above corresponds to further narrowing a pass band for spatial frequency of incident light (image). Specifically, only a component in lower frequency band passes through the aperture as the transmission region narrows, and thereby the aperture acts as a low pass filter.

### [Nonlinearity Problem of a Hologram Recording and Reproducing System]

As an approach for achieving the high density recording as above, there are two high density recording techniques, one of which is where a DC component is suppressed by using phase modulation recording by the phase mask 102 or the like and the other of which is where the area taken up by a hologram page is reduced by the aperture 105.

Ideally, it is preferable to use both of the high density recording techniques.

However, the high density recording technique of suppressing a DC component by performing the phase modulation recording using the phase mask 102 or the like tends to expand spatial frequency of an image in Fourier plane of signal light due to the uniform scattering of the spectrum mentioned above. Therefore, when the aperture 105 narrows the diameter of the signal light, that is, the light passes through a filter limiting the high-pass band of spatial frequency, considerable distortion occurs. Accordingly, inter-symbol interference tends to be promoted, and as a result, it is difficult to appropriately reproduce recorded data.

At that time, in order to suppress the inter-symbol interference, it has been attempted that filter processing (equalization filter) is performed for improving the characteristic of the spatial frequency for a read signal compared to the related art. In addition, the case of the equalization filter processing may be understood that the filter processing is 2-dimensionally expanded to suppress the inter-symbol interference, which is, for example, generally performed in fields of optical discs, communication, and the like.

Please refer to Japanese Unexamined Patent Application Publication No. 2008-152827 for details of the filter processing for suppressing the inter-symbol interference as above.

However, in the hologram recording and reproducing system of the related art, the equalization filter for suppressing the inter-symbol interference does not function well. Accordingly, it is very difficult to make compatible the high density recording by the phase modulation recording as above and the high density recording by the aperture 105.

The equalization filter processing for suppressing the inter-symbol interference does not function well because of the nonlinearity problem of the hologram recording and reproducing system of the related art.

In other words, the hologram recording and reproducing system of the related art has nonlinearity in that the system can record information of light intensity and phase on a medium, but can detect only the information of the light intensity by the image sensor 104 during reproduction. Specifically, in FIG. 17, it was described that the amplitude of 3 values, which are “0”, “+1”, and “−1” (combination of intensity 1 and phase π), can be recorded by the phase mask 102. However, as understood by the point, the hologram recording medium HM can record information on the phase as well as information on the light intensity. On the other hand, the image sensor 104 detects only the information on the light intensity in which the value of amplitude has been squared and made into an absolute value, and therefore, is nonlinear.

Because of the nonlinearity problem, it is difficult to achieve both of the high density recording techniques by the phase modulation recording and the aperture 105 in the hologram recording and reproducing system of the related art. In other words, it is necessary to achieve linear reading in which the information of the phase recorded on the hologram recording medium HM is also read, in order to realize both of the high density recording techniques.

### [Linear Reading by the Coherent Addition Method]

The present applicant previously suggested that a linear reading technique as a so-called “coherent addition method” as disclosed in Japanese Unexamined Patent Application Publication No. 2008-152827, in order to realize the linear reading as above.

Here, the reason of the nonlinearity problem is because the image sensor which performs light-reception for a reproduced image does not detect the wave-front amplitude of light, and can detect only the information of light intensity of which the value of the amplitude is squared (having an absolute value). Specifically, the amplitude “−1” and “+1” recorded by the phase modulation recording can be detected only as light intensity “1”.

The “coherent addition method” illuminates DC light having intensity and phase (that is coherent) in addition to reference light for obtaining a reproduced image as light illuminated during reproduction. Accordingly, a component of DC light+a reproduced image is detected in an image sensor.

Here, it is assumed that an amplitude value of an actual recording signal of light subjected to intensity modulation according to data “1” and further subjected to phase modulation by data “0” in the phase mask 102 (in other words, light generated as amplitude “+1”) is “0.078”. In addition, it is assumed that an amplitude value of an actual recording signal of light subjected to the intensity modulation according to data “1” and further subjected to phase modulation by data “π” in the phase mask 102 (in other words, light generated as amplitude “−1”) is “−0.078”. In other words, the maximum value of the signal amplitude is “0.078”, and the minimum value of the signal amplitude is “−0.078”.

At this point, the detecting result in the hologram recording and reproducing system of the related art is the same result, which is “0.078²”, and thereby it is not possible to reproduce phase information. In other words, nonlinear distortion occurs.

On the other hand, it is assumed that an addition of DC light is performed for a reproduced image as above. At this point, it is assumed that the addition amount of the DC light is “0.1”

Then, the maximum value “0.078” is detected with the light intensity of “0.032” rather than “0.178²”, and the minimum value “−0.078” is detected with the light intensity of “0.00048” rather than “0.022²”.

As such, according to the “coherent addition method”, light generated as the amplitude “+1” and “−1” can each be detected with different intensity. In other words, it is possible to perform the linear reading that does not lose recorded phase information.

### [Differential Detection Method]

Furthermore, the applicant suggested a reading technique of so-called “differential detection method” as a technique of linear reading, to which the “coherent addition method” is further developed, as disclosed in Japanese Unexamined Patent Application Publication No. 2008-310924, for example.

In the “differential detection method”, DC light having the same phase as a reproduced image (referred to as a first DC light) and DC light including phase difference it from the reproduced image (referred to as a second DC light) are added to the reproduced image, a detected image of “the reproduced image+the first DC light” and a detected image of “the reproduced image+the second DC light” are obtained, and then a linear reading signal is obtained due to a difference of the images.

As disclosed in Japanese Unexamined Patent Application Publication No. 2008-310924, according to the “differential detection method”, it is possible to achieve the linear reading and further to enhance the quality of reproducing signals resulting from the effect of suppressing noise superimposed on the DC light.

### SUMMARY OF THE INVENTION

As above, the “coherent addition method” and “differential detection method” previously suggested by the applicant can solve the nonlinearity problem existing in the hologram recording and reproducing system of the related art.

However, in the “coherent addition method”, there are problems that noise is superimposed on the DC light, and accordingly the quality of a reading result (a linear reading signal) deteriorates as the DC light passes the optical system and the hologram recording medium HM.

Furthermore, in the “differential detection method”, it is possible to solve the noise problem occurring in the “coherent addition method”, but the following problems may occur when employing the “differential detection method”.

As understood by the explanation above, in the “differential detection method”, it is necessary to generate two kinds of DC light phases of which are in an inverted relationship for a hologram page reading. In order to generate the two kinds of DC light having different phases, a phase modulator may be used, but it is necessary to generate the two kinds of DC light for a hologram page reading in the “differential detection method” as above. Therefore, a rate of reproduction and transfer mainly depends on the response speed of the phase modulator.

For that reason, in the “differential detection method”, a phase modulator having relatively high response speed is necessary for realizing a high rate of reproduction and transfer, and as a result, it is not possible to avoid an increase in manufacturing cost of a device.

Or, when a phase modulator having relatively low response speed is used to save costs, a decrease in the rate of reproduction and transfer inevitably occurs.

With consideration of the problems described above, a reproducing device of the present invention includes the following elements.

In other words, there is provided a light source that emits light for reproducing recorded information to a hologram recording medium subjected to recording of information by interference fringes of signal light and reference light in a unit of a hologram page.

Furthermore, there is provided a light irradiating unit that generates the reference light for obtaining a reproduced image according to the recorded information and DC light having uniform intensity and phase by subjecting the light from the light source to spatial light modulation, and irradiates the hologram recording medium with both the reference light and the DC light and with only the DC light.

Furthermore, there is provided a light receiving unit that performs light-reception for the DC light and the reproduced image obtained from the hologram recording medium caused by the irradiation of both the reference light and the DC light, and performs light-reception for the DC light obtained through the hologram recording medium by using the irradiation of only the DC light.

Moreover, there is provided a difference calculating unit that calculates a difference between an image signal obtained based on a light-reception result of the reproduced image and the DC light by the light receiving unit, and an image signal obtained based on a light-reception result of the DC light by the light receiving unit.

According to an embodiment of the present invention, it is possible to obtain a difference between a detected image signal for “reproduced image+DC light” obtained from the irradiation of the reference light and the DC light, and a detected image signal for the DC light obtained from the irradiation of only the DC light as in the “coherent addition method” in the related art (a DC light addition method).

As above, it is possible to eliminate a noise component superimposed on the DC light by calculating a difference between the detected image signal for “reproduced image+DC light” and the detected image signal for the DC light that is actually irradiated. In other words, since the same noise is generated in the DC light that is solely irradiated as that generated in the DC light (that is, the DC light added to a reproduced image) that is irradiated together with the reference light, it is possible to effectively suppress the noise superimposed on the DC light by subtracting the image signal for the DC light that is irradiated separately from the image signal for “reproduced image+DC light” as above.

As description for confirmation, the present invention performs the addition of the DC light in the same manner as in the “coherent addition method” of the related art, and therefore, there is no difference in that phase information is not lost in the light-reception result (detection result) in the light receiving unit in the same manner as in the “coherent addition method”. In other words, the present invention can perform the same linear reading as in the “coherent addition method”.

According to the embodiments of the present invention, the noise generated in the DC light added to the reproduced image can be eliminated by employing a reproducing technique that enables the linear reading as in the “coherent addition method” of the related art. In addition, due to the elimination of the noise in the DC light, the enhancement of the quality of the reproducing signal can be achieved.

If the quality of the reproducing signal is enhanced, it is possible to improve the recording density and the recording and reproduction rate.

According to the embodiments of the present invention, there is only one kind of the generated phase of the DC light, and thereby, it is not necessary to change the phase for each reading of a hologram as is necessary in the “differential detection method” of the related art.

Based on the above point, according to the embodiments of the present invention, it is not necessary to provide a phase modulator capable of responding at high speed in order to realize a high rate of reproduction and transfer, as in the case employing “differential detection method” of the related art. Accordingly, put simply, it is possible to reduce the manufacturing cost of a device.

Furthermore, even if a phase modulator having relatively slow response speed is used due to a priority of cost reduction, there is no situation where the rate of reproduction and transfer is sacrificed, as in the case of the “differential detection method”. Based on this point, according to the embodiment of the present invention, it is possible to enhance the rate of reproduction and transfer in comparison to the case where the “differential detection method” is employed.

### BRIEF DESCRIPTION OF THE DRAWINGS

FIG. 1 is a diagram illustrating an internal structure of a reproducing device according to an embodiment of the present invention;

FIGS. 2A and 2B are diagrams illustrating images of intensity modulation realized by a combination of a polarization controller and a polarizing beam splitter;

FIG. 3 is a diagram illustrating each area set in an intensity modulator and a phase modulator provided in the reproducing device according to an embodiment of the invention;

FIGS. 4A and 4B are diagrams schematically illustrating an output image of the intensity modulator and an output image of the phase modulator during recording;

FIG. 5 is a diagram schematically illustrating an output image of the phase modulator during DC light addition reading;

FIG. 6 is a diagram schematically illustrating an output image of the phase modulator during detection of only the DC light;

FIG. 7 is a diagram illustrating a linear reading technique as a first embodiment;

FIG. 8 is a timing chart relating to detection timing in an image sensor and the generation of reference light and DC light during reproduction in the first embodiment;

FIG. 9 is a diagram illustrating an inner structure of a data reproducing unit provided in the reproducing device of the embodiment;

FIG. 10 is a flowchart showing procedures supposed to be performed by a linearization processing unit provided in the reproducing device according to the first embodiment;

FIG. 11 is a timing chart relating to detection timing in an image sensor and the generation of reference light and DC light during reproduction according to a second embodiment;

FIG. 12 is a flowchart showing procedures supposed to be performed by a linearization processing unit provided in the reproducing device according to the second embodiment;

FIG. 13 is a diagram illustrating an internal structure of a recording and reproducing device according to a modified example in which spatial light modulation of signal light according to recorded data is performed with only phase modulation;

FIG. 14 is a diagram illustrating a structure of a light shielding mask provided in the recording and reproducing device according to the modified example;

FIG. 15 is a schematic diagram of an output image of a phase modulator during recording according to the modified example;

FIGS. 16A and 16B are schematic diagrams of output images (during DC light addition reading and detection of only DC light) of a phase modulator during reproduction according to the modified example;

FIG. 17 is a diagram illustrating an information recording technique on a hologram recording medium;

FIG. 18 is a diagram illustrating a reproducing technique of recording information on a hologram recording medium; and

FIG. 19 is a diagram illustrating an aperture.

### DESCRIPTION OF THE PREFERRED EMBODIMENTS

Hereinafter, exemplary embodiments of the invention will be explained.

In addition, the explanation will be provided in the following order.

<1. First Embodiment>

[1-1. Configuration of Recording and Reproducing Device]

[1-2. Linear Reading Technique of the First Embodiment]

[1-3. Configuration for Linear Reading]

[1-4. Summary of the First Embodiment]

<2. Second Embodiment>

<3. Modified Example>

### 1. First Embodiment

### 1-1. Configuration of Recording and Reproducing Device

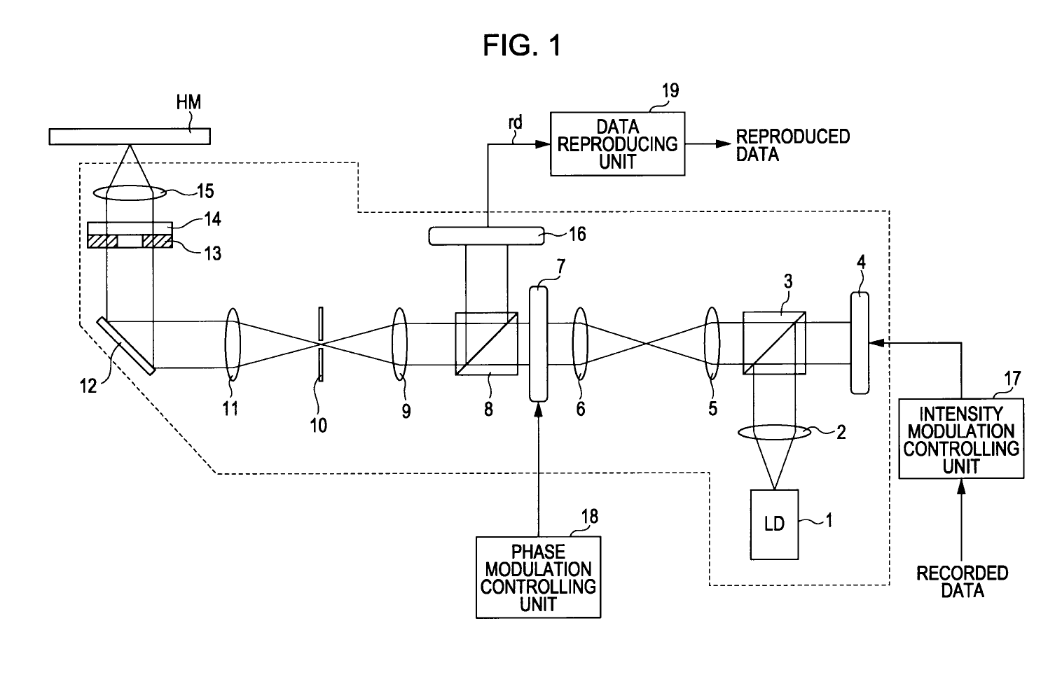

FIG. 1 is a diagram illustrating an internal structure of a hologram recording and reproducing device as an embodiment of a reproducing device of the present invention. Hereinafter, the hologram recording and reproducing device is also simply referred to as a recording and reproducing device.

In FIG. 1, the hologram recording medium HM is a recording medium on which information recording is performed by interference fringes of signal light and reference light.

The hologram recording medium HM is selected as a recording material, for example a photopolymer, that enables information recording due to a change in refractive index according to intensity distribution of reference light, and accordingly the information recording is performed by interference fringes of the signal light and the reference light. In addition, the hologram recording medium HM of the case is a reflection-type recording medium including a reflective film.

In the recording and reproducing device shown in FIG. 1, the hologram recording medium HM is held to be rotatably driven by a spindle motor, which is not shown in the drawing.

In the recording and reproducing device, light (recording and reproducing light) having a laser diode (LD) 1 as a light source in the drawing for recording and reproducing of a hologram is irradiated onto the hologram recording medium HM which is held as above.

In FIG. 1, an optical pickup including an optical system for irradiating the hologram recording medium HM with the recording and reproducing light is shown surrounded by a broken line. Specifically, within the optical pickup, there are provided the laser diode 1, a collimation lens 2, a polarizing beam splitter 3, a polarization controller 4, a relay lens 5, a relay lens 6, a phase modulator 7, a polarizing beam splitter 8, a relay lens 9, an aperture 10, a relay lens 11, a mirror 12, a partial diffractive element 13, a quarter wavelength plate 14, an objective lens 15, and an image sensor 16.

The laser diode 1 emits violet-blue laser light of about the wavelength of, for example, λ=405 nm as hologram recording and reproducing light. The laser light emitted from the laser diode 1 is incident on the polarizing beam splitter 3 via the collimation lens 2.

The polarizing beam splitter 3 transmits one linearly polarized light component out of linearly polarized light components each orthogonal to the incident laser light, and reflects the other linearly polarized light component. For example, in that case, it is configured that p-polarized light component is transmitted and s-polarized light component is reflected.

Accordingly, only the s-polarized light component of the laser light incident on the polarizing beam splitter 3 is reflected and guided to the polarization controller 4.

The polarization controller 4 includes reflection type liquid crystal element as, for example, ferroelectric liquid crystal (FLC), and is configured to control a polarizing direction for incident light in a unit of a pixel.

The polarization controller 4 changes the polarizing direction of incident light by 90° for each pixel according to a driving signal from an intensity modulation controlling unit 17 described below, or performs spatial light modulation without changing the polarizing direction of the incident light. Specifically, the polarization controller 4 is configured to perform the control of a polarizing direction according to a driving signal in a unit of a pixel by changing by 90° the polarizing direction for a pixel having an ON state of the driving signal and changing by 0° the polarizing direction for a pixel having an OFF state of the driving signal.

In the same manner as in the drawing, the light emitted from the polarization controller 4 (light reflected on the polarization controller 4) is incident again on the polarizing beam splitter 3.

Here, in the recording and reproducing device shown in FIG. 1, spatial light intensity modulation (referred to as light intensity modulation, or simply referred to as intensity modulation) is performed in a unit of a pixel by using the control of a polarizing direction in a unit of a pixel by the polarization controller 4 and the characteristics of selective transmission/reflection of the polarizing beam splitter 3 according to a polarizing direction of incident light.

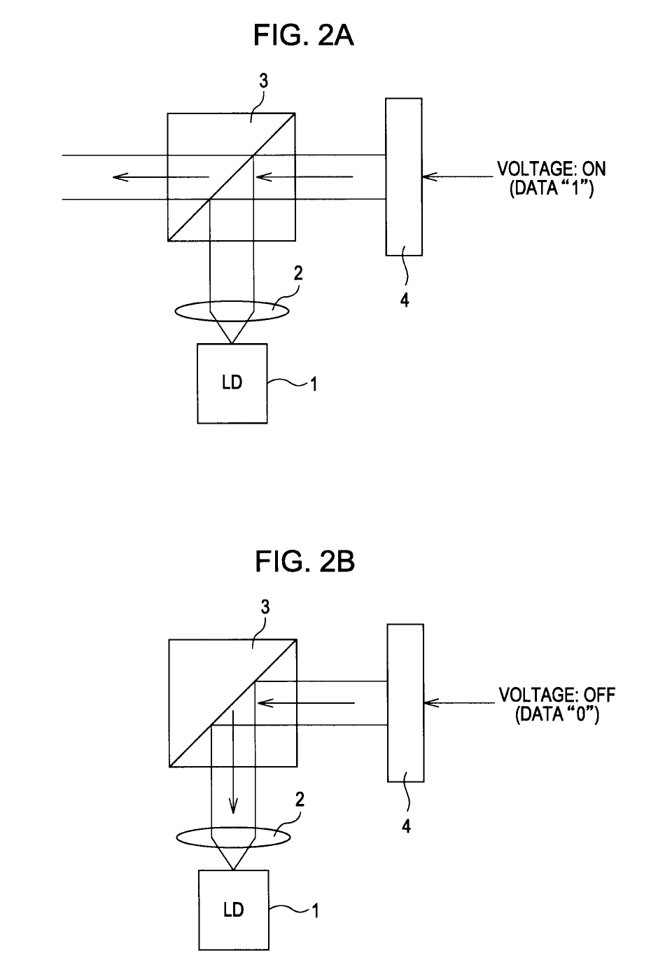

FIGS. 2A and 2B show an image of intensity modulation realized by the combination of the polarization controller 4 and the polarizing beam splitter 3. FIGS. 2A and 2B schematically show the states of light beams of an on-pixel and an off-pixel, respectively.

As described above, since the polarizing beam splitter 3 transmits the p-polarized light and reflects s-polarized light, the s-polarized light is incident on the polarization controller 4.

Based on the above premise, light of a pixel (light of a pixel with an ON-state driving signal) with a polarizing direction changed by 90° in the polarization controller 4 is incident on the polarizing beam splitter 3 as p-polarized light. In this way, the light of the on-pixel in the polarization controller 4 is transmitted through the polarizing beam splitter 3, and guided to the hologram recording medium HM side (FIG. 2A).

On the other hand, the light of the pixel with the OFF-state driving signal without a change in the polarizing direction is incident on the polarizing beam splitter 3 as s-polarized light. In other words, the light of the off-pixel in the polarization controller 4 is reflected on the polarizing beam splitter 3, and guided to the hologram recording medium HM side (FIG. 2B).

In that manner, with the combination of the polarization controller 4 as a spatial light modulator of a polarizing direction controlling type and the polarizing beam splitter 3, an intensity modulating unit that performs light intensity modulation in a unit of a pixel is formed.

Here, the recording and reproducing device according to the embodiment employs the coaxial method as a hologram recording and reproducing method. In other words, signal light and reference light are arranged on the same optical axis, irradiated together onto a hologram recording material set in a predetermined position via an objective lens, and thereby data is recorded by formation of a hologram. In addition, for the reproduction, the reference light is irradiated onto the hologram recording material via the objective lens to obtain a reproduced image of a hologram, and thereby the recorded data is reproduced.

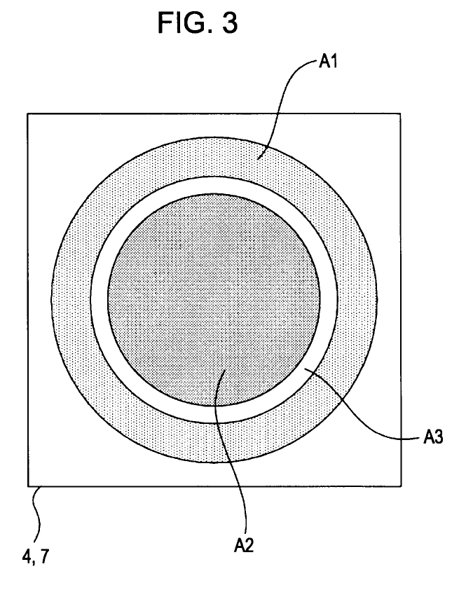

When the coaxial method is employed, in order to arrange the signal light and the reference light on the same optical axis, each area is set in the polarization controller 4 as shown in FIG. 3.

As shown in FIG. 3, in the polarization controller 4, a circular area with a predetermined range including a center thereof (same as a center of the optical axis) is set as a signal light area A2. In addition, outside of the signal light area A2, an annular-shaped reference light area A1 is set having a gap area A3 therebetween.

The signal light area A2 can be irradiated such that the signal light and the reference light are arranged on the same optical axis by the setting of the reference light area A1.

Furthermore, the gap area A3 is defined as a region to prevent noise in the signal light due to the leakage of the reference light generated in the reference light area A1 into the signal light area A2.

In addition, to describe for confirmation, since a pixel of the polarization controller 4 has a rectangle shape, the signal light area A2 technically is not a circle. Similarly, the reference light area A1 and the gap area A3 technically are not annular shapes. In that sense, the signal light area A2 is an area with a substantially circular shape, and the reference light area A1 and the gap area A3 are also areas with substantially annular shapes.

In FIG. 1, the intensity modulation controlling unit 17 controls driving of the polarization controller 4 to generate signal light and reference light during recording.

Specifically, during recording, the intensity modulation controlling unit 17 generates a driving signal so that pixels within the signal light area A2 in the polarization controller 4 have ON/OFF patterns according to supplied recorded data, pixels within the reference light area A1 have predetermined ON/OFF patterns, which are determined in advance, and other pixels have OFF patterns as a whole, and the driving signal is supplied to the polarization controller 4. With spatial light modulation by the polarization controller 4 based on the driving signal (controlling in a polarizing direction), the signal light and the reference light (both of which are intensity-modulated) arranged so as to have the optical axis of laser light in the centers thereof are obtained as light emitted from the intensity modulating unit including the polarization controller 4 and the polarizing beam splitter 3.

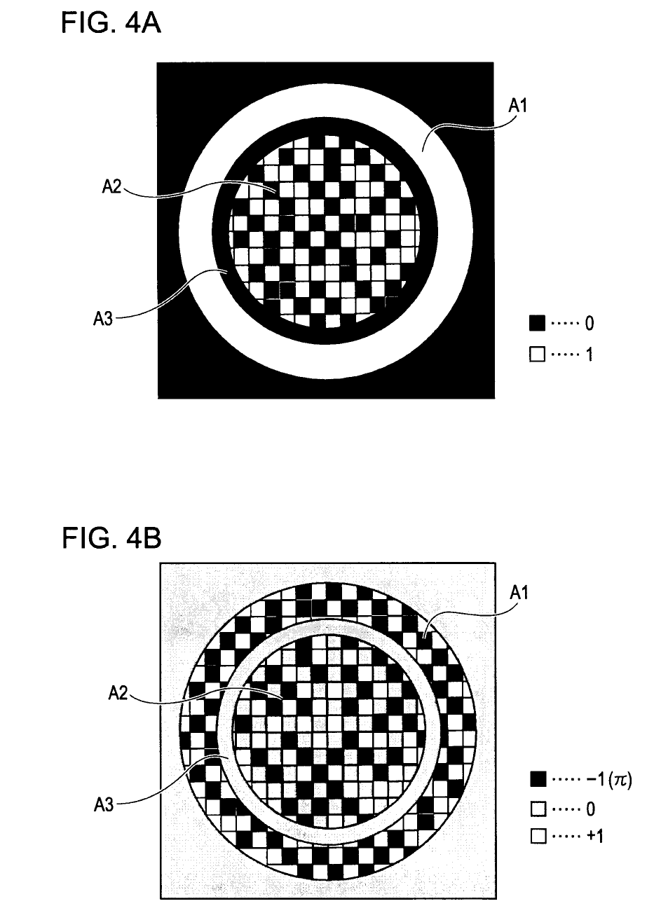

FIG. 4A schematically shows an image output from the intensity modulating unit according to the control of the intensity modulation controlling unit 17 during recording.

In FIG. 4A, the magnitude of the amplitude of light is indicated by strength of a color, and black represents amplitude “0”, and white represents amplitude “1”.

As shown in the drawing, patterns corresponding to recorded data of “0” and “1” are shown in the signal light area A2 during recording.

Moreover, in the case as shown in the drawing, a so-called solid pattern, which all pixels are “1” as an intensity pattern of the reference light area A1, is employed. In other words, the pattern of all “1” is set in the case as the “predetermined ON/OFF patterns, which are determined in advance” described above.

Furthermore, during recording, the intensity modulation controlling unit 17 generates the ON/OFF patterns within the signal light area A2 for a predetermined unit of input recorded data column, and thereby operating so as to sequentially generate the signal light storing data for the predetermined unit of the recorded data column. Accordingly, data are sequentially recorded on the hologram recording medium HM in a unit of a hologram page (a unit of data that enables recording by one interference of the signal light and the reference light).

In FIG. 1 again, the intensity modulation controlling unit 17 performs controlling in order to generate at least the reference light during reproduction.

Here, in the present embodiment as described later, DC light as well as the reference light is generated in the same manner as in the “coherent addition method” during the reproduction, but for convenience' sake, only modulation control in the generation of the reference light during the reproduction will be explained here, and the generation of the DC light will be explained later again.

The intensity modulation controlling unit 17 controls the driving of the polarization controller 4 by the driving signal that causes pixels at least within the reference light area A1 to have the predetermined ON/OFF patterns for the generation of the reference light during the reproduction.

Here, in order to appropriately obtain a reproduced image for the recorded hologram, it is necessary to generate and illuminate reference light having the same patterns of intensity and phase as the illuminated reference light during the recording. To that end, the pattern of the intensity modulation for the reference light generated during the reproduction has to be the predetermined ON/OFF patterns (in this case, the solid pattern mentioned above).

The laser light subjected to the intensity modulation by the polarizing beam splitter 3 and the polarization controller 4 in the intensity modulating unit passes through the relay lens 5 and the relay lens 6, and is incident on the phase modulator 7.

The phase modulator 7 performs spatial light phase modulation (simply referred to as phase modulation) for the incident light in a unit of a pixel.

Here, as the phase modulator 7 used in the present embodiment, a transmissive phase modulator capable of performing variable phase modulation in a unit of a pixel is used. Specifically, this is a transmissive phase modulator which can variably modulate phase from “0” to “π” according to the level of a driving signal.

As such, it is possible to use a modulator, for example, described in Japanese Unexamined Patent Application Publication No. 2008-152827 mentioned above as a phase modulator capable of performing variable phase modulation in a unit of a pixel.

The phase modulator 7 undertakes a function for realizing the high density recording by phase modulation recording, as the phase mask 102 described above.

Here, in the present embodiment, the following is the reason for using the phase modulator 7 capable of performing variable phase modulation in a unit of a pixel as described above.

In order to suppress a DC component as the phase mask 102, phase modulation by 2 values of random phase patterns, for example, “0” and “π”, is performed with respect to the signal light during the recording. However, in the case of the present embodiment, in order to perform the addition of the DC light to be described later, it is necessary to assign predetermined patterns for all pixels within the signal light area A2 (for example, phase modulation by “π/2” to be described later) during the reproduction. From this point, in the case of the present embodiment, it is necessary to switch phases assigned in the signal light area A2 during the recording and the reproduction, and to this end, the phase modulator 7 capable of performing variable phase modulation is used.

The driving control for the phase modulator 7 is performed by a phase modulation controlling unit 18.

The phase modulation controlling unit 18 performs the driving control so that the phase modulator 7 can carry out functions of the phase mask 102 during the recording.

In the case of the present embodiment, 2 values of random phase patterns are set for the phase modulation patterns as the phase mask 102. In other words, the phase modulation controlling unit 18 performs the driving control for pixels in the phase modulator 7 based on the phase modulation patterns (patterns of “0” and “π”) that are determined in advance as the 2 values of random phase patterns.

FIG. 4B schematically shows the image output from the phase modulator 7 by the driving control of the phase modulation controlling unit 18 during the recording.

The magnitude of the amplitude of the light is indicated by the strength of a color also in FIG. 4B, and black represents an amplitude “−1”, gray represents an amplitude “0”, and white represents an amplitude “1”.

As shown in FIG. 4B, with the driving control of the phase modulation controlling unit 18 during the recording, “+1”, “0”, and “−1” are randomly generated within the signal light area A2.

Furthermore, within the reference light area A1, “+1” and “−1” are randomly generated. Which is to say in this case, since the intensity modulation pattern of the reference light area A1 is a solid pattern by “1”, “0” does not exist within the reference light area A1.

The phase modulation controlling unit 18 performs the driving control of the phase modulator 7 so that, during the reproduction, the reference light is subjected to a phase modulation by the same phase patterns as in recording. However, in the present embodiment, the phase modulation controlling unit 18 not only performs the driving control for such phase modulation to the reference light, but also performs the driving control for a phase modulation to DC light (generated in the signal light area A2) during the reproduction.

The phase modulation during the reproduction in the present embodiment including the phase modulation to the DC light will be explained later again.

The multiple recording of a hologram page was explained above, but in case of performing the multiple recording, the multiple recording is performed on a hologram page by successively changing the patterns (intensity and phase) of the reference light during recording.

Furthermore, during reproduction of a hologram page subjected to the multiple recording, it is possible to selectively read a target hologram page by setting the same patterns (intensity and phase) of the reference light as those in the recording.

Here, in the recording and reproducing device shown in FIG. 1, in order to accurately assign a phase modulation pattern determined in advance in a unit of a pixel for the reference light and the signal light generated by the intensity modulating unit (the polarizing beam splitter 3 and the polarization controller 4), it is necessary to take optical matching (pixel matching) of each pixel of the polarization controller 4 and each pixel of the phase modulator 7.

To that end, the phase modulator 7 is provided in an optical system such that a modulation plane (real image plane), which is formed by a relay lens system including the relay lenses 5 and 6 shown in FIG. 1, of the polarization controller 4 is positioned in a plane conjugated therewith. In addition to that, the arranged position of the phase modulator 7 in a plane orthogonal to a laser optical axis is determined such that light passing through each pixel of the polarization controller 4 is incident on each of corresponding pixels in the phase modulator 7.

As understood by the above description, areas including the reference light area A1, the signal light area A2, and the gap area A3 are set in the phase modulator 7 in the same manner as in the polarization controller 4 (refer to FIG. 2), and accordingly it is possible to perform the phase modulation in the areas of the reference light area A1 and the signal light area A2.

In FIG. 1, the light emitted from the phase modulator 7 is incident on the polarizing beam splitter 8.

The polarizing beam splitter 8 is configured to transmit the p-polarized light and reflect the s-polarized light in the same manner as the polarizing beam splitter 3, and accordingly, the laser light emitted from the phase modulator 7 transmits the polarizing beam splitter 8.

The laser light transmitting the polarizing beam splitter 8 is incident on a relay lens system including the relay lens 9, the aperture 10, and the relay lens 11.

As shown in the drawing, the beams of the laser light transmitting the polarizing beam splitter 8 are condensed to a predetermined focal position by the relay lens 9, and the beams of the laser light are converted to be parallel light by the relay lens 11 as diffusing light after the condensation of the light. The aperture 10 is provided in a focal position (Fourier plane: frequency plane) by the relay lens 9, and configured to transmit light within a predetermined range around the center of an optical axis and shield other light.

The aperture 10 limits the size of a hologram page recorded on the hologram recording medium HM, and may enhance the recording density of a hologram (in other words, data recording density).

The optical axis of the laser light passing through the relay lens 11 is bent by 90° by the mirror 12, and is guided to the objective lens 15 via the partial diffractive element 13 to a quarter wavelength plate 14.

The partial diffractive element 13 and a quarter wavelength plate 14 are provided in order to prevent the reference light reflected on the hologram recording medium HM (reflected reference light) during the reproduction from being noise for reproduced light guided to the image sensor 16.

Furthermore, suppressing action of the reflected reference light by the partial diffractive element 13 and a quarter wavelength plate 14 will be described later.

The laser light incident on the objective lens 15 is irradiated so as to be condensed on the hologram recording medium HM.

Here, as described above, the signal light and the reference light are generated by the intensity modulation by the intensity modulating unit (the polarization controller 4 and the polarizing beam splitter 3) during the recording, and the signal light and the reference light are irradiated on the hologram recording medium HM through the route as described above. Accordingly, the hologram recording medium HM is formed with a hologram reflecting recorded data generated by interference fringes of the signal light and the reference light, and thereby data recording is realized.

Furthermore, during the reproduction, the reference light is generated by the intensity modulator and irradiated on the hologram recording medium HM through the process described above. With the irradiation of the reference light as above, a reproduced image (reproduced light) is obtained as reflected light according to a hologram formed during the recording. The reproduced image returns to the device via the objective lens 15.

Here, the reference light irradiated on the hologram recording medium HM during the reproduction (referred to as traveling reference light) is incident on the partial diffractive element 13 as p-polarized light according to the operation of the intensity modulating unit above. Since the partial diffractive element 13 transmits the entire traveling light as described below, the traveling reference light as p-polarized light passes through the quarter wavelength plate 14. As such, the traveling reference light as p-polarized light that has passed through the quarter wavelength plate 14 is converted to a circularly-polarized light in a predetermined rotation direction and irradiated on the hologram recording medium HM.

The reference light irradiated as above is reflected on a reflective film provided in the hologram recording medium HM, and guided to the objective lens 15 as reflected reference light (returning reference light). At this point, since the rotation direction of the circularly-polarized light of the returning reference light is shifted to an opposite rotation direction to the predetermined rotation direction by the reflection on the reflective film, the returning reference light is converted to s-polarized light passing through the quarter wavelength plate 14.

Herein, based on the transitions of the polarization state as described above, the suppressing action of the reflected reference light by the partial diffractive element 13 and the quarter wavelength plate 14 will be described.

The partial diffractive element 13 is formed with a polarization selective diffractive element having a selective diffraction property according to a polarization state of linearly polarized light component (one component of the linearly polarized light component is diffracted and the other component of the linearly polarized light is transmitted), for example, a liquid crystal diffractive element, in a region where the reference light is incident (region other than the center portion). In this case, specifically, the polarization selective diffractive element provided in the partial diffractive element 13 transmits p-polarized light and diffracts s-polarized light. In this way, the traveling reference light is transmitted through the partial diffractive element 13 and only the returning reference light is diffracted (suppressed) in the partial diffractive element 13.

As a result, the reflected reference light as returning light is detected as a noise component for a reproduced image, and thereby a decrease in S/N ratio can be prevented.

As description for confirmation, a region where the signal light is incident in the partial diffractive element 13 (a region where the reproduced image or DC light described below is incident during the reproduction) is constituted with a transparent material or holes so as to transmit both the traveling light and the returning light. With the configuration, the signal light during the recording and the reproduced image during the reproduction (and the DC light described below) are transmitted through the partial diffractive element 13.

Here, as understood by the explanation hitherto, in the hologram recording and reproducing system, the reference light is irradiated to the recorded hologram, and thereby the reproduced image is obtained by using the diffraction, but the diffraction efficiency at that point is generally less than several % to 1%. For that reason, the reference light returning to a device side as reflected light has great intensity for the reproduced image. Which is to say, in the detection of the reproduced image, the reference light as the reflected light becomes a noise component that may not be ignored.

Therefore, the suppression of the reflected reference light is achieved by the partial diffractive element 13 and the quarter wavelength plate 14 as above, and thereby the S/N ratio may be greatly improved.

The reproduced image obtained in the reproduction as above is transmitted to the partial diffractive element 13. The reproduced image transmitted to the partial diffractive element 13 is reflected on the mirror 12, passes through the relay lens 11 to the aperture 10 and to the relay lens 9 as described above, and is incident on the polarizing beam splitter 8. As understood by the explanation hitherto, since the reflected light from the hologram recording medium HM is converted to s-polarized light through the quarter wavelength plate 14, the reproduced image incident on the polarizing beam splitter 8 is reflected on the polarizing beam splitter 8 and guided to the image sensor 16.

The image sensor 16 includes an image capturing device, for example, a charged coupled device (CCD) sensor or complementary metal oxide semiconductor (CMOS) sensor, performs light-reception of the reflected light (only the reproduced image, herein) from the hologram recording medium HM guided as above, and obtains an image signal by converting the light to an electric signal. The image signal obtained as above becomes a signal reflecting ON/OFF patterns (in other words, data patterns of “0” and “1”) assigned to a signal light during recording. In other words, the image signal detected in the image sensor 16 as above becomes a reading signal of the data recorded on the hologram recording medium HM.

The reading signal obtained by the image sensor 16 (hereinafter, referred to as reading signal rd) is supplied to a data reproducing unit 19.

The data reproducing unit 19 reproduces recorded data and outputs the data as reproduced data in the drawing based on the reading signal rd.

Furthermore, the internal structure of the data reproducing unit 19 and the specific processing will be described later.

### 1-2. Linear Reading Technique of the First Embodiment

In the present embodiment, in order to solve the nonlinearity problem existing in the hologram recording and reproducing system in the related art, where only reference light is irradiated during reproduction, a technique is employed for generating and illuminating DC light of which the intensity and the phase are uniformly processed during the reproduction, in addition to the reference light, as in the “coherent addition method” disclosed in Japanese Unexamined Patent Application Publication No. 2008-152827 presented above.

As description for confirmation, the DC light is generated within the signal light area A2 so as to be obtained in a position which overlaps the reproduced image in the image sensor 16, as disclosed in Japanese Unexamined Patent Application Publication No. 2008-152827.

As described before, however, the addition of the DC light may lead to the deterioration of the reproducing signal quality because of the noise generated until the DC light is guided to the image sensor 16 via the optical system and the hologram recording medium HM.

Therefore, in the present embodiment, by employing a technique to be described later, it is possible to realize nonlinear reading by the addition of the DC light and to enhance the reproducing signal quality by removing the noise superimposed on the DC light.

In the present embodiment, the reference light and DC light are generated and irradiated for the reproduction of a hologram, and thereby, light-reception is performed for the reproduced image+the DC light to obtain the image signal for “reproduced image+DC light” in the same manner as in the “coherent addition method”.

In addition to that, in the present embodiment, only the DC light is generated and irradiated, and thereby, the light-reception is performed for the DC light via the optical system and the hologram recording medium HM to obtain the image signal for only the DC light.

Moreover, a technique is employed for taking a difference between the image signal for “reproduced image+DC light” and the image signal for only the DC light.

### (Regarding the Generation of the DC Light)

First, there will be explanation given about the DC light.

In the case of the present embodiment, the DC light has intensity and phase that are uniformly processed as described above (in other words, regarded as coherent light).

Furthermore, in addition to that, it is presumed that light having the same phase as the standard phase of the reproduced image is generated as such DC light in this example.

Here, the “standard phase of the reproduced image” refers to a phase of data pixels subjected to modulation by a phase “0” and then recorded.

By making the DC light have the same phase as the phase of the reproduced image, it is possible to add the DC light as a component of the same phase to the reproduced image. In other words, it is possible to add amplitude “1” to the reproduced image when, for example, the DC light is generated with modulation by intensity “1”.

In the present embodiment, both the DC light and the reference light are generated and only the DC light is generated during the reproduction.

Specific operation of intensity modulation controlling unit 17 and the phase modulation controlling unit 18 for generating both the DC light and the reference light, and generating only the DC light will be explained.

First, the intensity modulation controlling unit 17 sets the same ON/OFF patterns as in the recording as ON/OFF patters of the reference light area A1 when both the DC light and the reference light are generated during the reproduction. Furthermore, the intensity modulation controlling unit 17 sets a pattern making the entire of the signal light area A2 to be ON (“1”), and sets a pattern making a region other than the reference light area A1 and the signal light area A2 to be OFF (“0”).

Based on the ON/OFF patterns of the entire effective pixels of the polarization controller 4 set as above, the intensity modulation controlling unit 17 performs driving control for each pixel of the polarization controller 4. Accordingly, it is possible to obtain light in a state where the reference light and the DC light have not been subjected to phase modulation.

In addition, the phase modulation controlling unit 18 performs the following operation when both the DC light and the reference light are generated during the reproduction.

First, in the reference light area A1, a phase pattern is set as the same 2 values of random phase patterns as in the recording as described above. Then, in the signal light area A2, the phase “π/2” is set for the entire area. Since the region other than the reference light area A1 and the signal light area A2 has intensity “0” as above, the reproduction result does not change even when any phase modulation is performed. In this example, the region other than the reference light area A1 and the signal light area A2 are set to phase “0”.

Here, the phase modulator 7 as described above is configured to variably modulate the phase from “0” to “π” according to the driving signal level. Corresponding to that, the phase modulation controlling unit 18 is configured to set the driving signal level between “0” and “1” (for example, 0 to 255 in case of 256-grayscale).

In other words, pixels to be subjected to modulation by the phase “0” have the driving signal level of “0”, pixels to be subjected to modulation by the phase “π” have the driving signal level of “255”, and pixels to be subjected to modulation by the phase “π/2” have the driving signal level of “127”.

The phase modulation controlling unit 18 performs the driving control for each pixel of the phase modulator 7 by the driving signal of each pixel set with the level thereof according to the phase pattern for all of the effective pixels of the phase modulator 7. Accordingly, the reference light having the same patterns (intensity and phase) as in the recording and the DC light by the intensity “1” and phase “π/2” are obtained as an output from the phase modulator 7.

Here, in the example, the phase of the DC light is the same phase as the standard phase in the reproduced image as described above. It can be understood that, in the “same phase as the standard phase in the reproduced image”, the value of the phase that the phase modulator 7 assigned to the DC light (in the signal light area A2) is “π/2” when the phase modulator 7 has the standard phase of “0” as the phase of the pixels subjected to modulation with the phase “0” during the recording.

The reason for performing the phase modulation by “π/2” for the DC light as above is as follows.

In the hologram recording and reproducing method, when the reference light is irradiated on the hologram recording medium HM to obtain the reproduced image, a phenomenon occurs such that the phase of the reproduced image is deviated by π/2 from the phase of the recording signal (as for this point, refer to “Coupled wave theory for thick hologram grating” written by Kogelnik, H., Bell System Technical Journal, 48, 2909 to 47). From this point, the standard phase in the reproduced image is deviated by “π/2”, without being maintained with “0”, and in order to correspond to that, it is preferable to set the phase for the DC light as “π/2”.

As such, in the generation of the DC light, it is preferable to subject each pixel within the signal light area A2 in the phase modulator 7 to modulation by the phase “π/2”.

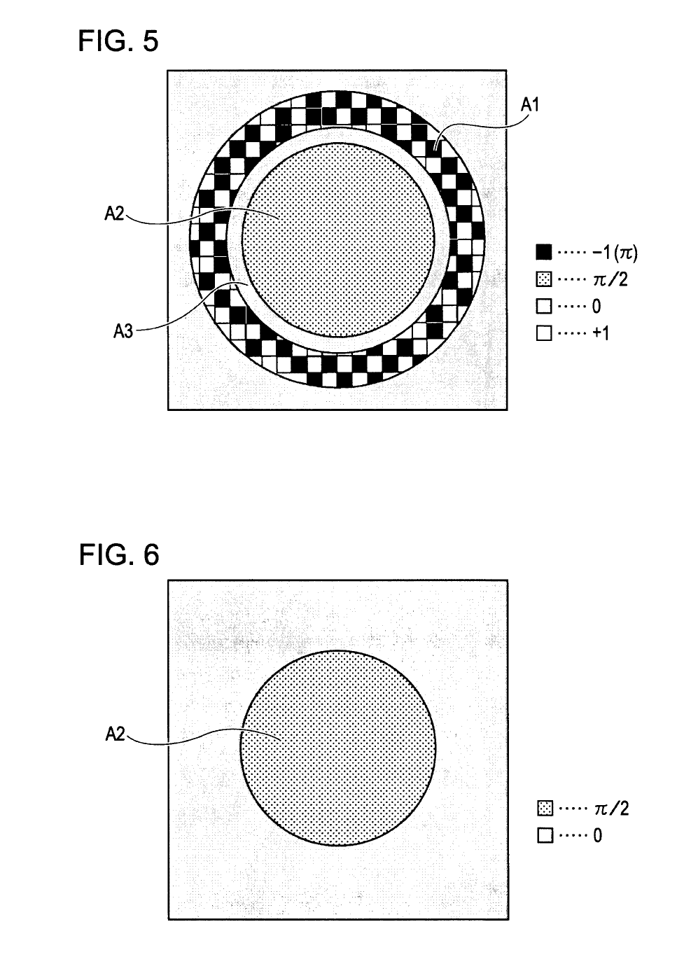

For reference, in FIG. 5, when the driving control is performed by the intensity modulation controlling unit 17 and the phase modulation controlling unit 18 described above, the image output from the phase modulator 7 is schematically shown. Furthermore, in FIG. 5, white represents amplitude “+1” (a combination of the intensity “1” and the phase “0”), gray represents amplitude “0”, and black represents amplitude “−1” (a combination of the intensity “1” and the phase “π”). The part of dot pattern in the drawing represents modulated part by the combination of the intensity “1” and the phase “π/2”.

Furthermore, in the present embodiment, during the reproduction, only the DC light is generated.

When only the DC light is generated as above, the intensity modulation controlling unit 17 sets ON/OFF patterns having ON (“1”) for the entire region of the signal light area A2, and OFF (“0”) for other region, and performs driving control for each pixel of the polarization controller 4 based on the patterns.

In addition, during the generation of only the DC light, the phase modulation controlling unit 18 performs driving control for each pixel of the phase modulator 7 by the driving signal based on patterns having a value corresponding to the phase “π/2” for the signal light area A2 (“127” in this case as described above) and “0” for other region.

By the driving control of the intensity modulation controlling unit 17 and the phase modulation controlling unit 18, only the DC light by the intensity “1” and the phase “π/2” is obtained as output of the phase modulator 7.

FIG. 6 schematically shows the image output from the phase modulator 7 when the driving control is performed for the generation of only the DC light by the intensity modulation controlling unit 17 and the phase modulation controlling unit 18. Furthermore, in FIG. 6, gray represents amplitude “0”, the dot pattern represents modulated part by the combination of the intensity “1” and the phase “π/2”.

### (Specific Technique)

In the first embodiment, the generation of both the reference light and the DC light, and the generation of only the DC light are performed for each reading of a hologram. In other words, the image signal of only the DC light subtracted from the image signal for “reproduced image+DC light” is successively obtained for each reading of a hologram.

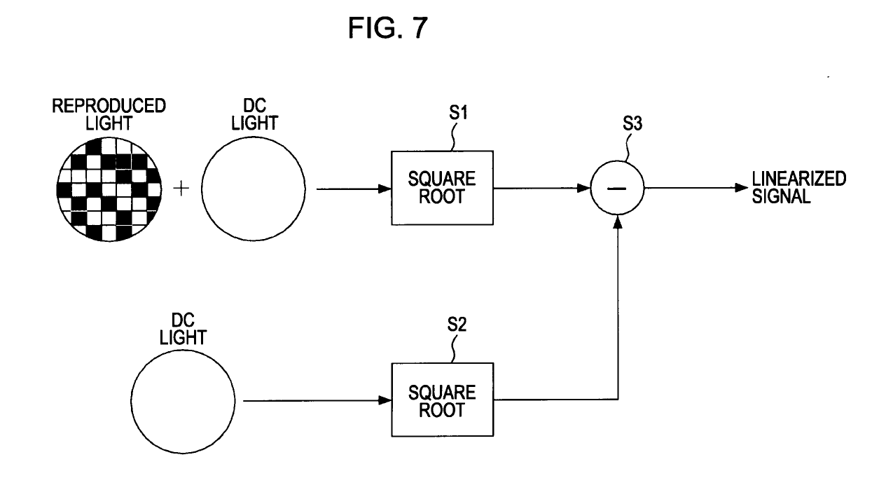

FIG. 7 is a diagram illustrating linear reading of the first embodiment.

In FIG. 7, a technique of linear reading corresponding to reading of any one hologram is shown.

As shown in FIG. 7, according to the generation and irradiation of both the reference light and the DC light, light-reception is performed for a component added with the DC light and the reproduced image for a hologram to be read.

In addition, light-reception is performed for only the DC light as in the drawing in the generation and irradiation of only the DC light.

In the present embodiment, with respect to each image signal obtained based on each light-reception operation performed for each reading of a hologram page, the square roots are calculated as shown by S1 and S2 in FIG. 7. In addition to that, as shown by S3 in the drawing, the result of the square root calculation of the image signal for only the DC light obtained in the square root calculation of S2 is subtracted from the result of the square root calculation of the image signal for “reproduced image+DC light” obtained in the square root calculation of S1.

The result of the subtraction by S3 is a linearization signal (linear reading signal).

As description for confirmation, the square root calculation for the image signal is performed based on a detection value of each pixel (a value of detection intensity).

Furthermore, the subtraction of the two image signals is performed as a subtraction of the detection value of each pixel.

Here, it is necessary to make sure that linear reading is realized by the square root calculation and subtraction process. Furthermore, in the following description, it is assumed that the addition amount of the DC light (light intensity) is “1.0”. In addition, in this case, it is assumed that the amplitude in the reproduced image has a maximum value of “0.078” and the minimum value of “−0.078”.

With the addition of the DC light to the reproduced image, the detection intensity of the maximum value in the reproduced image is (0.078+1.0)²=1.162, and the detection intensity of the minimum value is (−0.078+1.0)²=0.850. Therefore, the results of the square root calculation by S1 are “1.078” and “0.922” respectively.

Moreover, the detection intensity for only the DC light is “1.0²”=“1.0”, and thereby the result of the square root calculation by S2 is “1.0”.

From this point, in the subtraction process by S3, the maximum value in the reproduced image is “1.078-1.0”, and the minimum value is “0.922-1.0”, and as a result, the original amplitude, which is ±0.078, is restored.

As understood by the above explanation, it is possible to realize linear reading that does not lose information of a recorded phase by employing the reading technique as the present embodiment described in FIG. 7.

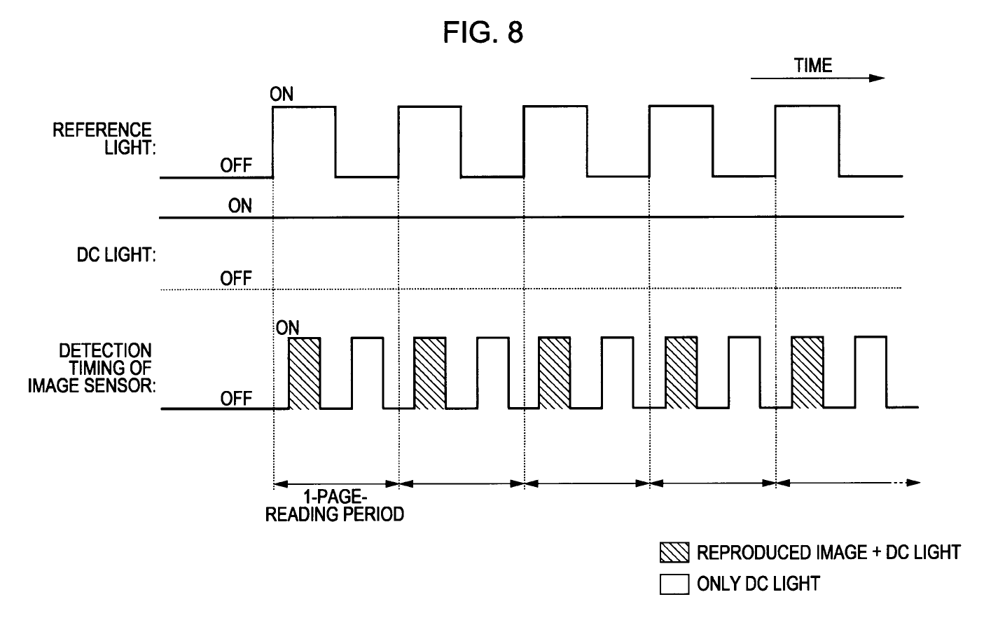

FIG. 8 is a timing chart relating to detection timing in the image sensor 16 and the generation of the reference light and the DC light during reproduction.

As clear from FIG. 8, when the generation of both the reference light and the DC light and the generation of only the DC light are performed for each reading of a hologram page, it is possible to maintain the DC light in ON state at all times.

On the other hand, the reference light repeats to be in ON/OFF state alternatively as the OFF period comes after the ON period in the reading period of a hologram page.

With the generation timing of the reference light and the DC light, it is possible to perform the generation of both the reference light and the DC light and the generation of only the DC light for each reading of a hologram page.

Furthermore, the image detection (light-reception operation) by the image sensor 16 is performed so as to be ON state during the ON period of both the reference light and the DC light and during the ON period of only the DC light for each reading period of a hologram page.

Accordingly, it is possible to obtain the result of the light-reception for “reproduced image+DC light” and the result of the light-reception for only the DC light for each reading of a hologram page.

### 1-3. Configuration for Linear Reading

In the present embodiment, the intensity modulation controlling unit 17 and the phase modulation controlling unit 18 shown in FIG. 1 above performs driving control of the polarization controller 4 and the phase modulator 7 so that the reference light and the DC light are generated by the timings shown in the timing chart of FIG. 8.

Specifically, the intensity modulation controlling unit 17 in reproduction performs the driving control of the polarization controller 4 so that intensity modulation is performed in the entire signal light area A2 to be ON “1” at all times, and in the reference light area A1 to be the same ON/OFF patterns (solid patterns in this case) as during the recording in the ON period of the reference light shown in FIG. 8.

Furthermore, the phase modulation controlling unit 18 during the reproduction performs the driving control of the phase modulator 7 so that the modulation is performed in the entire signal light area A2 by the phase “π/2” at all times and in the reference light area A1 by the same phase pattern as during the recording in the ON period of the reference light shown in FIG. 8.

Furthermore, as understood by the explanation of FIG. 8, the image sensor 16 shown in FIG. 1 performs image detection (light-reception operation) during the period when the reference light and the DC light obtained for each reading period of a hologram page are ON and the period when only the DC light is ON.

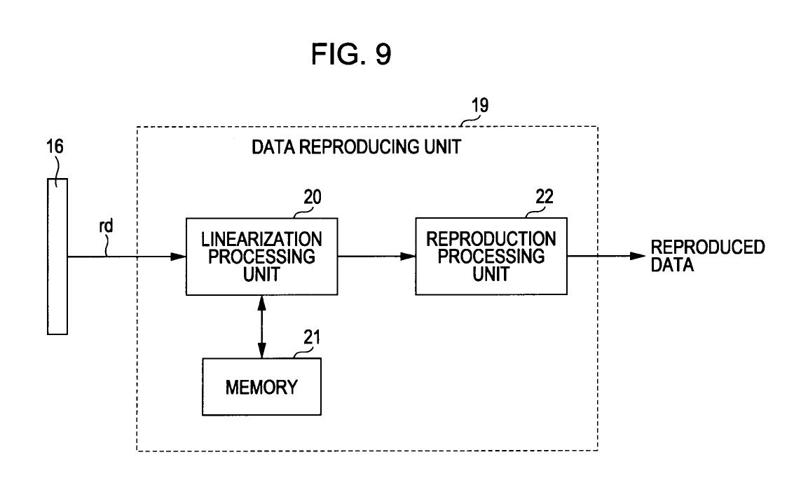

FIG. 9 illustrates the internal structure of a data reproducing unit 19 shown in FIG. 1 above.

Furthermore, FIG. 9 also illustrates the image sensor 16 shown in FIG. 1.

The data reproducing unit 19 is provided with a linearization processing unit 20, a memory 21, and a reproduction processing unit 22 as shown in the drawing.

The linearization processing unit 20 obtains a linearization signal (linear reading signal) by performing the square root calculation (S1 and S2) and the subtraction process (S3) described in FIG. 7 above by using the memory 21 in the FIG. 9 based on the reading signal rd by the image sensor 16.

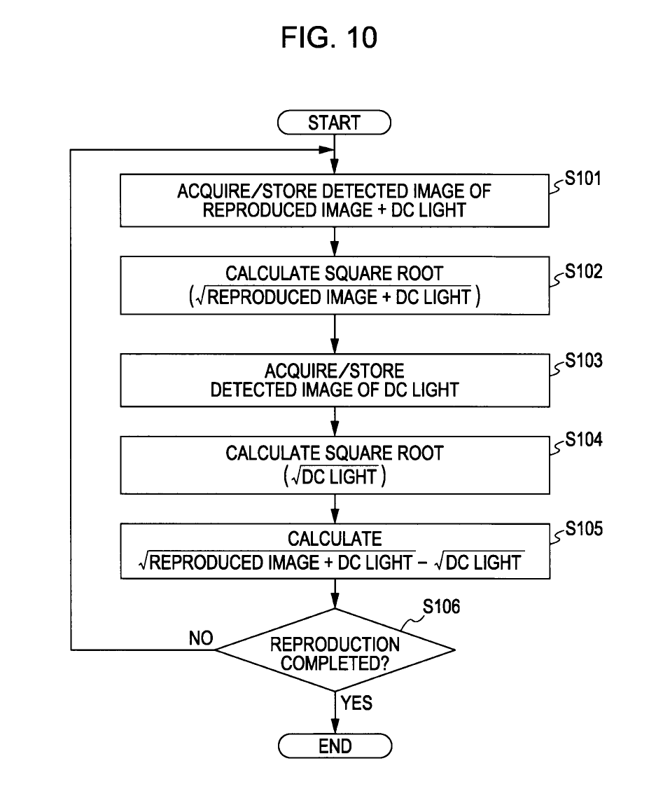

FIG. 10 is a flowchart showing procedures performed by the linearization processing unit 20.

First, in step S101, the detected image of the reproduced image+the DC light is obtained and stored. In other words, the reading signal rd obtained in the image sensor 16 according to the generation and irradiation of both the reference light and the DC light is acquired, and the reading signal rd is stored in the memory 21.

Next, in step S102, the square root is calculated. In other words, the square root for the detected image of the reproduced image+the DC light stored in step S101 above is calculated. Here, the result of the square root calculation for the detected image of the reproduced image+the DC light is expressed by “√ reproduced image+DC light” as shown in FIG. 10.

Subsequently, in step S103, the detected image of the DC light is acquired and stored. In other words, the reading signal rd obtained in the image sensor 16 according to the generation and irradiation of only the DC light is acquired, and the reading signal is stored in the memory 21.

Furthermore, in step S104, the square root of the detected image of the DC light stored in step S103 is calculated as a calculation process of the square root. The result of the square root calculation for the detected image of the DC light is expressed by “√ DC light”.

Subsequently, in step S105, “√ reproduced image+DC light“−”√ DC light” is calculated. Thereby, a linear reading signal (linearization signal) for a hologram is obtained.

Next, in step S106, it is determined whether the reproduction is completed or not. In other words, it is determined whether the reproduction for all holograms as reproduction targets is completed or not.

In step S106, when there is a negative result that the reproduction is not completed, the process returns to step S101.

On the other hand, when there is a positive result that the reproduction is completed, the process shown in the drawing ends.

The linearization processing unit 20 shown in FIG. 9 can realize the process shown in FIG. 10 by setting up a circuit. In other words, it is possible by using hardware.

Or, it is possible by using software, for example, by realizing a digital signal processor (DSP) that executes a digital signal processing complying with a program for executing the processing operation shown in FIG. 10.

As above, a linearization signal for each hologram page can be obtained by the processing of the linearization processing unit 20.

The linearization signal obtained in the linearization processing unit 20 is supplied to the reproduction processing unit 22.

The reproduction processing unit 22 performs a reproduction processing in order to reproduce recorded data, including a predetermined reproducing signal processing for the linearization signal and a data identification processing for each pixel based on the result of the reproducing signal processing.

As the reproducing signal processing performed for the linearization signal as above, the equalization filter processing for suppressing inter-symbol interference described above and the like can be exemplified.

Furthermore, various kinds of techniques for reproducing recorded data from the linearization signal have been considered, but the embodiments herein do not have any particular limit on the use of those techniques.

### 1-4. Summary of the First Embodiment

In the present embodiment as explained above, the image signals are obtained for “reproduced image+DC light” by generating and illuminating the reference light and the DC light and for only the DC light by generating and illuminating only the DC light. In addition to that, the difference is obtained between the image signal for “reproduced image+DC light” and the image signal for only the DC light.

By employing the technique as above, linear reading that does not lose phase information recorded on the hologram recording medium HM is realized, and then the noise superimposed on the DC light can be eliminated.

Accordingly, put simply, in comparison to the “coherent addition method” in the related art that enables the same linear reading, it is possible to further enhance quality of the reproducing signal.

With the enhanced quality of the reproducing signal, it is possible to improve recording density and a rate of recording and reproduction.

Moreover, according to the present embodiment, it is possible to have only one kind of a phase of the DC light generated during the reproduction. Accordingly, as in the “differential detection method” in the related art, it is not necessary to change the phase of the DC light for each reading of a hologram.

From this point, according to the present embodiment, as in the case where the “differential detection method” in the related art is employed, it is not necessary to provide a phase modulator capable of performing high-speed response in order to realize high rate of reproduction and transfer. Accordingly, put simply, it is possible to reduce the manufacturing cost of a device.

Furthermore, according to the present embodiment, even when a phase modulator having relatively slow-speed response is used due to a priority of cost reduction, it is possible to avoid a situation where the rate of reproduction and transfer is sacrificed as in the case of using the “differential detection method”. From this point, put simply, it is possible to improve the rate of reproduction and transfer in the present embodiment, in comparison to a case employing the “differential detection method”.

Furthermore, in the present embodiment, the generation and the irradiation of the reference light and the DC light and of only the DC light are performed for each reading of a hologram. In other words, the image signal of only the DC light subtracted from the image signal of “reproduced image+DC light” is successively obtained for each reading of a hologram.

Accordingly, it is possible to improve the effect of eliminating the noise superimposed on the DC light.

In other words, the noise superimposed on the DC light may be caused by an optical system starting from, for example, a light source (the laser diode 1 in FIG. 1) and by a medium when the light passes through a hologram recording medium HM. The noise caused by a medium may possibly change according to a reproduction position on the medium.

As described above, if the image signal of only the DC light subtracted from the image signal of “reproduced image+DC light” is successively obtained for each reading of a hologram, even when the noise caused by the medium changes according to the change of the reproduction position, it is possible to eliminate the noise.

As understood by the above explanation, according to the present embodiment, it is possible to effectively eliminate the noise caused by the optical system in addition to the noise caused by the medium, and as a result, it is possible to obtain the effect of eliminating the noise superimposed on the DC light to the utmost.

Furthermore, in the present embodiment, after each of the square roots of the image signal for the reproduced image+the DC light and the image signal for only the DC light are calculated, a difference thereof is calculated. However, the above calculation can improve the effect of eliminating the noise in comparison to a case where the square roots are not calculated before the calculation of the difference.

### 2. Second Embodiment

Successively, the second embodiment will be explained.

In the second embodiment, the generation and irradiation of only the DC light and the acquisition of the detected image are performed once for a reading of a plurality of holograms. In other words, the image signal of only the DC light subtracted from the image signal of “reproduced image+DC light” is obtained once for a reading of the plurality of holograms.

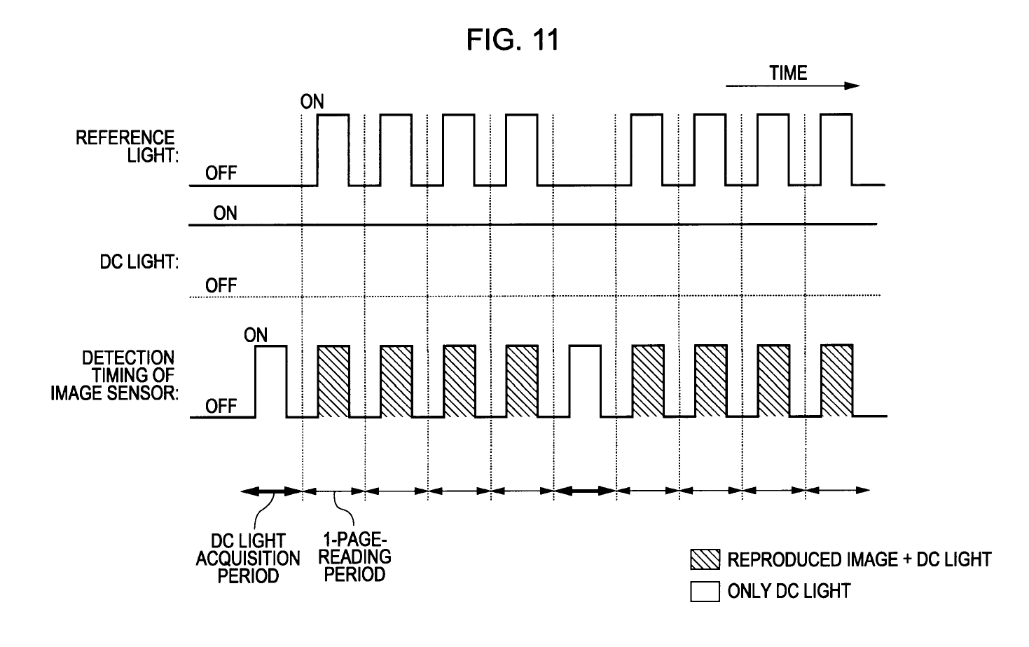

FIG. 11 is a timing chart relating to the generation of the reference light and the DC light and the detection timing in the image sensor 16 during the reproduction of the second embodiment.

First, as understood from FIG. 11, the generation and irradiation of only the DC light are performed once for a reading of four holograms, as an example in this case.

As shown in the drawing, in the second embodiment, there are one-page-reading periods indicated by thin arrows and a DC light acquisition period indicated by thick arrows.

Specifically, in this case, after the generation and irradiation of only the DC light and acquisition of the detected image thereof are performed, the generation and the irradiation of both the reference light and the DC light and the acquisition of the detected image are repeatedly performed for four holograms.

As shown in the FIG. 11, it is possible to maintain the DC light to be in ON state at all times during the reproduction also in this case.

Furthermore, it is repeatedly performed that the reference light is in OFF state during the DC light acquisition period, and then successively in ON state for each period of four one-page-readings.

In that way, a combination of one DC light acquisition period and four one-page-reading periods are repeated, and then a difference relating to the image signal of “reproduced image+DC light” is calculated for each of four one-page-reading periods after the DC light acquisition period by using the image signal of only the DC light acquired in the previous DC light acquisition period (which is a DC light image for subtraction).

Specifically, also in this case, since the square root is calculated before the difference calculation as in the first embodiment, the square root for the DC light image for subtraction acquired in the DC light acquisition period is calculated (√ DC light). In addition, in one-page-reading period thereafter, the square root for the image signal of the acquired “reproduced image+DC light” is calculated (1 reproduced image+DC light), and then the result of the square root calculation “√ DC light” is subtracted from the result of the square root calculation “√ reproduced image+DC light”.

Accordingly, it is possible to obtain linear reading signal by “√ reproduced image+DC light“−”√ DC light” for each one-page-reading period.

Here, also in the second embodiment has the same internal structure of the recording and the reproducing device as described in the first embodiment (FIG. 1 and FIG. 9).

As understood by the above explanation, however, it is necessary to change the timing of generating the reference light to the timing in the first embodiment.

Specifically, the intensity modulation controlling unit 17 in this case performs the driving control of the polarization controller 4 so that the signal light area A2 is in ON state (“1”) at all times during the reproduction as in the case of the first embodiment, and that the reference light area A1 is subjected to intensity modulation by the same ON/OFF patterns as in the recording for each one-page-reading period shown in FIG. 11.

Furthermore, during the reproduction, the phase modulation controlling unit 18 performs the driving control of the phase modulator 7 so that the signal light area A2 is subjected to modulation by phase “π/2” at all times in the same manger as in the first embodiment, and the reference light area A1 is subjected to modulation by the same phase pattern as in the recording for each one-page-reading period shown in FIG. 11.

Moreover, in the second embodiment, the image sensor 16 performs image detection (light-reception operation) in each period of the one-page-reading period and of the DC light acquisition period shown in FIG. 11.

In addition, in the second embodiment, the detail of the linearization processing performed by the linearization processing unit 20 is different.

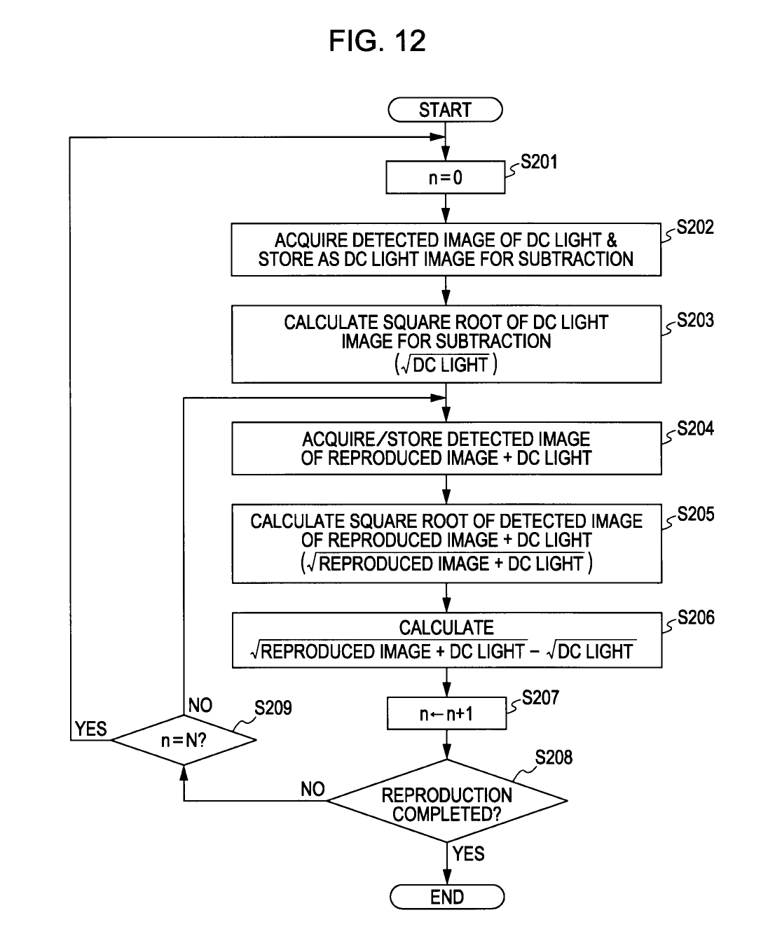

The flowchart of FIG. 12 shows procedures to be performed by the linearization processing unit 20 in the second embodiment.

In FIG. 12, the number of readings n is reset to 0 in step S201. As understood by the following explanation, the number of readings n is a value obtained by counting the number of acquisitions of hologram pages after the DC light acquisition period.

Next, in step S202, the detected image of the DC light is acquired, and the result is stored in the memory 21 as a DC light image for subtraction.

Furthermore, in the next step of S203, the square root of the DC light image for subtraction is calculated. As described above, the calculated value of the square root for the DC light image for subtraction is indicated by “√ the DC light”.

Subsequently, in step S204, the detected image of the reproduced image+the DC light is acquired, and the result is stored in the memory 21.

Furthermore, in the next step S205, the square root of the detected image of the reproduced image+the DC light (“√ reproduced image+DC light”) is calculated.

Next, in step S206, “√ reproduced image+DC light“−”√ DC light” is calculated. With the difference calculation, it is possible to obtain the linear reading signal for a hologram which is a reading target in the n-th one-page-reading period after the DC light acquisition period.

Subsequently, in step S207, the number of readings n is increased (n←n+1).

Furthermore, in the next step S208, it is determined whether the reproduction has been completed or not.

In this step S208, when there is the result that the reproduction has not been completed, the process advances to step S209, and it is determined whether n=N.

Here, the “N” is a value representing the number of one-page-reading periods provided after the DC light acquisition period. In other words, the value “N” is a parameter of determining how many times the DC light image for subtraction acquired in the DC light acquisition period is used in the one-page-reading periods for the difference calculation.

As understood from the above explanation, the N is set to 3 corresponding to 4 times in this example.

In step S209 above, when there is the negative result of n≠N (in other words, when it is a timing when the DC light image for subtraction is not supposed to be newly acquired), the step returns to step S204.

Furthermore, in step S209 above, when there is the positive result of n=N (in other words, when it is a timing when the DC light image for subtraction is supposed to be newly acquired), the step returns to step S201.

Accordingly, it is possible to use the DC light image for subtraction acquired during the previous DC light acquisition period for the difference calculation until reading of the hologram is performed N times.

Furthermore, in step S208 above, when there is a positive result that the reproduction has been completed, the process shown in the drawing ends.

Moreover, in this case, it is possible to mount the linearization processing unit 20 as either hardware or software.

According to the second embodiment described above, it is preferable that the acquisition of the detected image of only the DC light is performed one time for a plurality of readings of holograms, and it is possible to enhance the reproduction and transfer rate as much as in comparison to the first embodiment.

Here, in the second embodiment, the setting of the value “N” described in FIG. 12, in other words, the setting of how many times the DC light image for subtraction is newly acquired for readings of the hologram pages depends on the reproduction and transfer rate, and the prevention of noise caused by a medium. Particularly, it is possible to improve the prevention of the noise caused by a medium if the value “N” is small, but the reproduction and transfer rate tends to deteriorate. To the contrary, the reproduction and transfer rate tends to be enhanced if the value “N” is large, but the prevention of the noise caused by a medium deteriorates.

Furthermore, if the value “N” is at the maximum, in other words, if the acquisition of the DC light image for subtraction is performed one time for each loading of a hologram recording medium HM, the prevention of the noise caused by a medium is at the minimum, but it is possible to obtain the same degree of the prevention of noise caused by an optical system as in the first embodiment.

### 3. Modified Example

Hitherto, the embodiments of the present invention have been explained, but the invention is not limited to the specific examples described above.

For example, in the explanation above, the square root calculation is inserted before the difference calculation, but the square root calculation is not a key process in the invention. Particularly, as explained in the above examples, if the addition amount of the DC light (light intensity) is “1.0”, and the maximum value of the amplitude is “0.078” and the minimum value thereof is “−0.078” during the reproduction, for example, when the square root calculation is not inserted, it is possible to calculate the difference between the detected intensity=1.0 (1.0²) for only the DC light and the detected intensity of the maximum value=(0.078+1.0)²=1.162 and the detected intensity of the minimum value=(−0.078+1.0)²=0.850 during the reproduction, but the calculation results are the maximum value side=1.162−1.0=0.162, and the minimum value side=0.850−1.0=−0.150, which are different from each other.

As understood from that point, even when the square root calculation is not inserted, it is possible to distinguish a signal recorded as the amplitude “1” (the maximum value side) from a signal recorded as the amplitude “−1”, and as a result, it is possible to perform linear reading that does not lose phase information.

As description for confirmation, since the elimination of the addition amount of the DC light is performed by using the detected image of the DC light that is actually irradiated in the above case, it is possible to eliminate the noise superimposed on the DC light.

Furthermore, in the explanation hitherto, during the recording, there is an example where the DC light is generated with intensity modulation by the intensity “1” (in other words, the addition amount of the DC light for a reproduced image is set to a value corresponding to “1”), but the intensity of the DC light can be set to other values. In that case, the intensity modulating unit is configured to perform the intensity modulation which is variable within the range of the intensity “0” to “1”.

Furthermore, in the explanation hitherto, in order to set the phase of the DC light to “the same phase as the standard phase within the reproduced image”, the modulation by the phase “π/2” was performed in the phase modulator 7. However, in order to set the phase to “the same phase as the standard phase within the reproduced image”, it is preferable that the difference between the phase of the DC light and the phase of the light subjected to modulation by the phase “0” in the phase modulator 7 is “π/2”, and therefore, the value of the phase modulation for the DC light can be “3π/2”. Moreover, of course, the phase modulator 7 of the case is used with the modulation capability by at least from the phase “0” to “3π/2”.

Here, as description for confirmation, it is preferable that the DC light is uniformly added with a predetermined amplitude value for a reproduced image. As understood from this point, it is possible set the phase of the DC light to other phases without the necessity of setting to the same phase as the standard phase within the reproduced image.

In the explanation hitherto, there is an example where the pattern of the intensity modulation for the reference light is wet to a solid pattern by All “1”, but other patterns can be used.

Furthermore, in the explanation hitherto, there is an example where spatial light modulation for reflecting recorded data of “0” and “1” in the signal light is performed by the intensity modulation, but the invention can be appropriately applied also in the case where the spatial light modulation of the signal light corresponding to the recorded data is performed with the phase modulation.

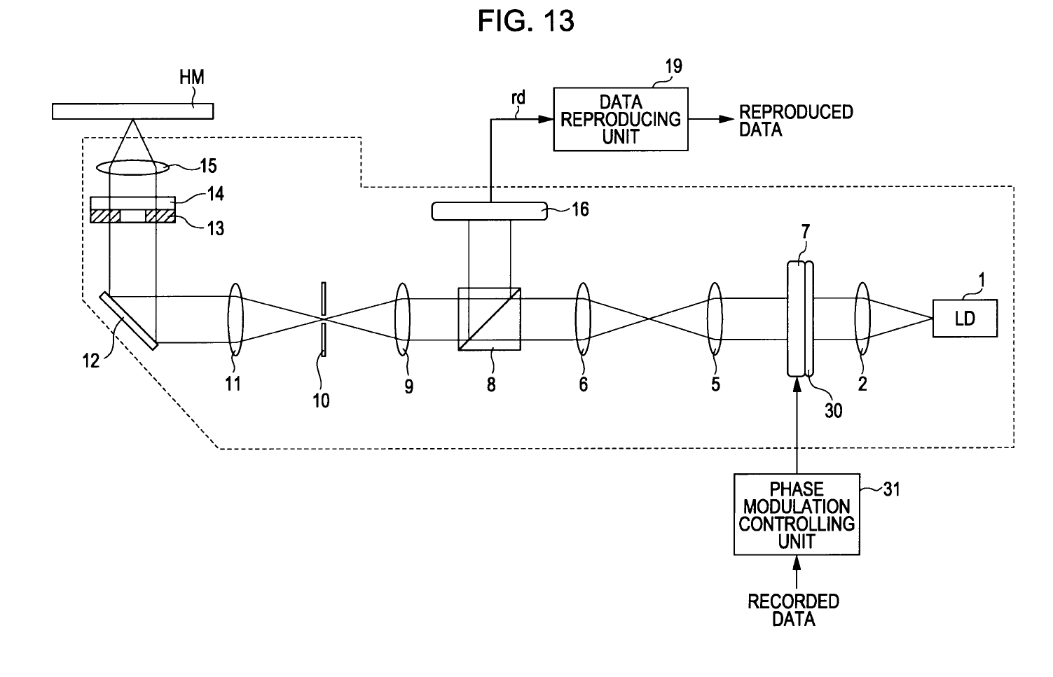

FIG. 13 shows the internal structure of the recording and reproducing device as a modified example where the spatial light modulation of the signal light corresponding to the recorded data is performed with the phase modulation. In addition, in this drawing, the same portions as those that have been explained hitherto were given with the same reference numerals and explanation thereof will not be repeated.

As understood by the comparison to FIG. 1 above, in the recording and reproducing device shown in FIG. 13, the intensity modulating part by the polarizing beam splitter 3 and the polarization controller 4 is omitted, and the phase modulator 7 is interposed between the collimation lens 2 and the relay lens 5.

In addition to that, a light shielding mask 30 is provided in the face where light from the laser diode 1 is incident for the phase modulator 7 of the case.

Furthermore, in this case, a phase modulation controlling unit 31 is provided instead of the phase modulation controlling unit 18 as a drive controlling unit for the phase modulator 7.

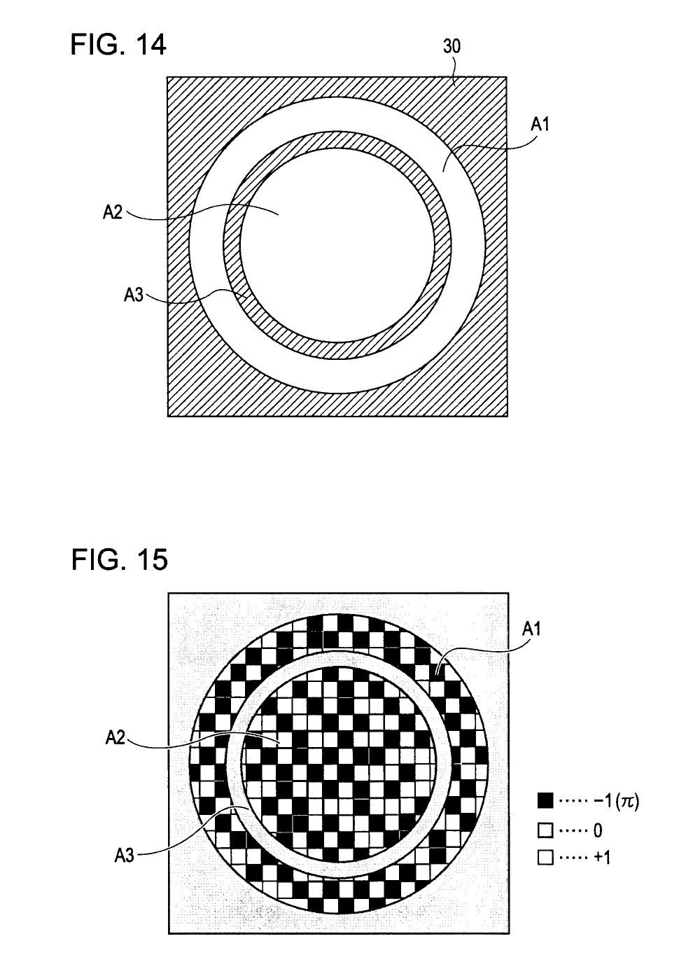

FIG. 14 shows the structure of the light shielding mask 30.

As shown in FIG. 14, in the light shielding mask 30, the reference light area A1, the signal light area A2 and the gap area A3 are set in the same size as those set in the phase modulator 7. In the light shielding mask 30, only the reference light area A1 and the signal light area A2 are formed of materials having transmissibility (for example, transparent glass or transparent resin), and other regions are formed of light shielding materials.

The light shielding mask 30 is provided on the modulation face of the phase modulator 7 such that the reference light area A1, the signal light area A2, an the gap area A3 thereof correspond to the reference light area A1, the signal light area A2, an the gap area A3 set in the phase modulator 7. With the light shielding mask 30 provided therein, it is possible to cut unnecessary light in the region not relevant to recording and reproduction as a region other than the reference light area A1 and the signal light area A2.

The same effect as that of the light shielding mask 30 can be obtained by coating the light shielding materials in the region of the modulation face of the phase modulator 7 (the region outside the gap area A3 and the reference light area A1).

The phase modulation controlling unit 31 shown in FIG. 14 sets the phase patterns according to the recorded data within the signal light area A2 during recording. For example, the phase patterns of “0” and “π” according to the recorded data within the signal light area A2 are set by assigning the phase “0” to pixels to be assigned with the recorded data “1” and the phase “π” to pixels to be assigned with the recorded data “0”.

Furthermore, in this case, the details of the driving control in the region other than the signal light area A2 during the recording and the driving control during the reproduction are the same as those in the phase modulation controlling unit 18 described above. Therefore, the explanation thereof will not be repeated.

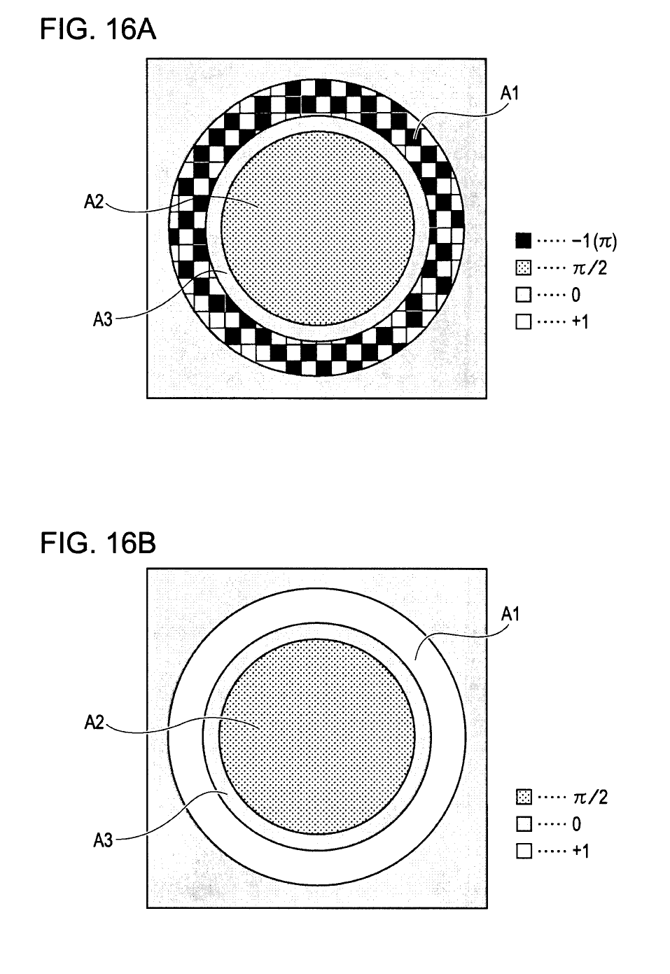

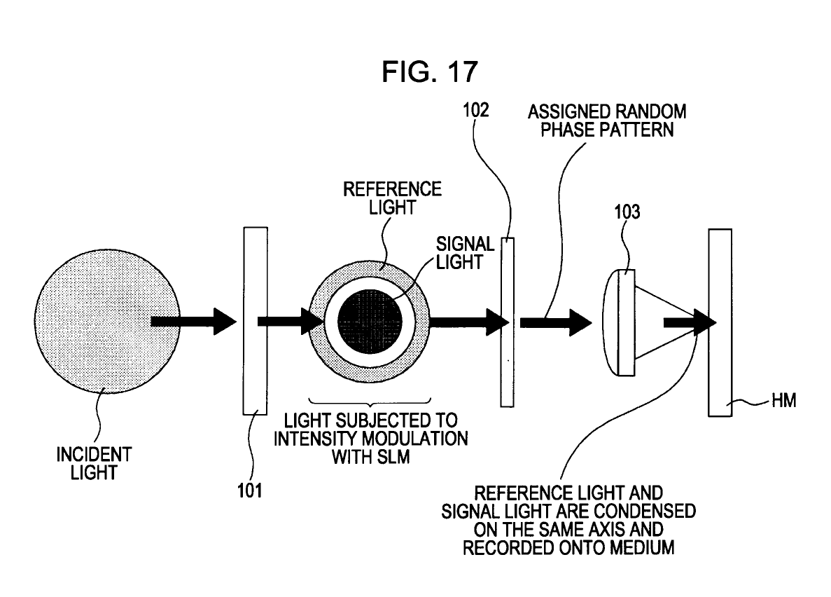

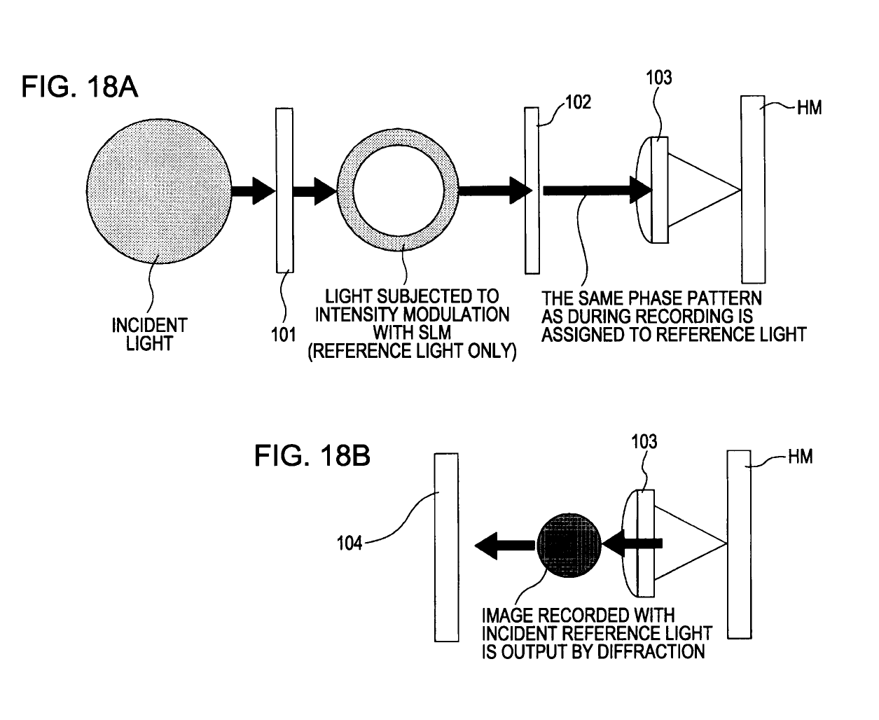

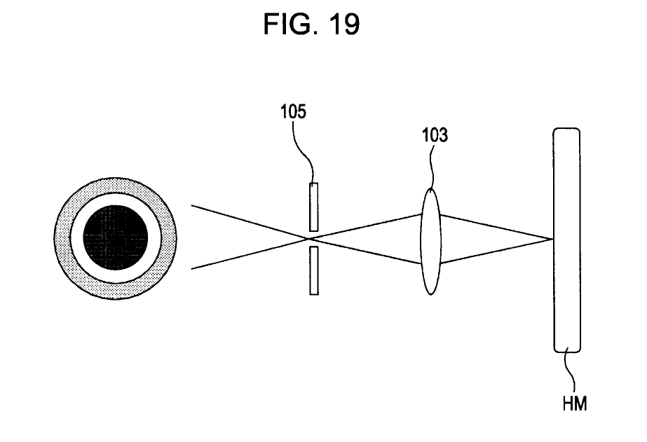

In order to confirm the above facts, FIGS. 15, 16A and 16B schematically show the output image of the phase modulator 7 in the modified example. FIG. 15 shows the output image during recording, FIG. 16A show the output image during reading of the DC light addition (during the generation both the reference light and the DC light), and FIG. 16B shows output image during the detection of only the DC light.

Furthermore, the magnitude of the amplitude is indicated by the strength of colors in FIG. 15, and black represents the amplitude “−1”, gray represents the amplitude “0”, and white represents the amplitude “1”.

Moreover, in FIG. 16A, black represents the amplitude “−1”, the dot pattern represents a combination of the intensity “1” and the phase “π/2”, gray represents the amplitude “0”, and white represents the amplitude “1”. In FIG. 16B, the dot pattern represents a combination of the intensity “1” and the phase “π/2”, gray represents the amplitude “0”, and white represents the amplitude “1”.

As shown in FIG. 15, since the intensity modulation according to the recorded data is not performed in this case, only the amplitude “1” and the amplitude “−1” exist within the signal light area A2 during the recording.

As understood by the comparison of FIG. 5 and FIG. 16A, the output image of the phase modulator 7 during the reading of the DC light addition is the same as in the case of the embodiments (because the intensity of the reference light and the DC light during the reproduction is a solid pattern of All “1” also in the embodiments).

Furthermore, as shown in FIG. 16B, during the detection of only the DC light in this case, the light transmitted to the reference light area A1 is obtained in addition to the DC light as the output image from the phase modulator 7.

However, since the light transmitted the reference light area A1 as above is suppressed by the suppression function of the reflected reference light by a combination of partial diffractive element 13 and the quarter wavelength plate 14 shown in FIG. 13, the detected image of the DC light can be obtained in the same manner as in the embodiments.

Here, in the case of the modified example, the amplitude “1” and “−1” of the reproduced image represents bit “1” and “0”. Accordingly, if the amplitude “1” and “−1” in the reproduced image can be distinguished from each other, it is possible to perform the data reproduction. In other words, in the case of the modified example, a condition for performing the data reproduction is to realize the linear reading.

As understood from the explanation above, as a recording and reproducing device in the modified example, during the reproduction, the acquisition of the detected image of “reproduced image+DC light” by the generation and irradiation of the reference light and the DC light, and the acquisition of the detected image of only the DC light by the generation and the irradiation of only the DC light are performed, and then the operation of calculating the difference between the image signal of “reproduced image+DC light” and the image signal of only the DC light is performed. Accordingly, put simply, the linear reading is realized also in the modified example.

As understood from the point, the present invention can be appropriately applied to the case where the signal light is generated by performing the phase modulation according to the recorded data.

Furthermore, in the first embodiment, the generation and the irradiation both the reference light and the DC light are performed, and then the generation and the irradiation of only the DC light is performed. However, it is possible to shift the order of the operations or to put different orders by the page reading period, and therefore, the operation is not particularly limited to the order.

Furthermore, in the explanation hitherto, it is premised that the exposure time of the image sensor 16 during the detection of “reproduced image+DC light” and the exposure time of the image sensor 16 during the detection of only the DC light are equal to each other, but the exposure time during the detection of only the DC light can be set shorter so as to aim at, for example, the enhancement of the reproduction and transfer rate.

However, the case where the exposure time during the detection of “reproduced image+DC light” and the exposure time during the detection of only the DC light are different causes a state where the detection intensity of the DC light does not correspond thereto, and thereby there may be a concern that the DC light component added to the reproduced image is not eliminated.

Therefore, in this case, the detection intensity of the DC light both of the operations has to be correspond to each other, and a gain may be adjusted to any one of the detected image of “reproduced image+DC light” and the detected image of only the DC light.

At this point, if the gain is adjusted to the detected image of “reproduced image+DC light” side, the detection intensity of the reproduced image becomes a different value from the intensity that it is supposed to obtain. For that reason, it is preferable that the gain adjustment is performed for only the detected image of only the DC light side.

Furthermore, it is needless to say that the gain adjustment can be performed for either the image signal before the square root calculation or the image signal after the square root calculation.

Furthermore, in the explanation hitherto, it is exemplified that the invention is applied to a recording and reproducing device capable both of the recording and reproduction of a hologram, but can be appropriately applied to a reproducing device capable of reproducing a hologram (reproduction-dedicated device).

Furthermore, a specific configuration (particularly, a configuration of an optical system within an optical pick-up) of the reproducing device is not limited to the examples shown above, but the configuration can be properly changed according to actual embodiments by, for example, employing an optical system corresponding to a transmissive hologram recording medium without a reflective film.

The present application contains subject matter related to that disclosed in Japanese Priority Patent Application JP 2009-053200 filed in the Japan Patent Office on Mar. 6, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A reproducing device comprising:
a light source that emits light for reproducing recorded information to a hologram recording medium subjected to recording of information by interference fringes of signal light and reference light in a unit of a hologram page;
a light irradiating unit that generates the reference light for obtaining a reproduced image according to the recorded information and DC light having uniform intensity and phase by subjecting the light from the light source to spatial light modulation, and irradiates the hologram recording medium with both the reference light and the DC light and with only the DC light;
a light receiving unit that performs light-reception for the DC light and the reproduced image obtained from the hologram recording medium caused by the irradiation of both the reference light and the DC light, and performs light-reception for the DC light obtained through the hologram recording medium caused by the irradiation of only the DC light; and
a difference calculating unit that calculates a difference between an image signal obtained based on a light-reception result of the reproduced image and the DC light by the light receiving unit, and an image signal obtained based on a light-reception result of the DC light by the light receiving unit.

2. The reproducing device according to claim 1, wherein the light irradiating unit irradiates the hologram recording medium with both the reference light and the DC light and irradiates with only the DC light for each reading of a hologram.

3. The reproducing device according to claim 1, wherein
the light irradiating unit irradiates the hologram recording medium with only the DC light once for a plurality of readings of holograms; and
the difference calculating unit calculates a difference between an image signal based on a light-reception result of only the DC light irradiated once for the plurality of readings of holograms and an image signal based on a plurality of light-reception results of the reproduced image and the DC light obtained during the plurality of readings of holograms.

4. The reproducing device according to claim 1, wherein, with respect to the light-reception result of the reproduced image and the DC light and the light-reception result of only the DC light, the difference calculating unit calculates square roots of intensity of light-receptions to obtain a first square root image signal and a second square root image signal, and then calculates a difference between the first square root image signal and the second square root image signal.

5. The reproducing device according to claim 1, wherein the difference calculating unit calculates a difference between the image signal obtained based on the light-reception result of the reproduced image and the DC light and the image signal obtained based on the light-reception result of only the DC light after adjusting a gain of at least one of the image signals.

6. A reproducing method of performing reproduction for a hologram recording medium subjected to recording of information by interference fringes of a signal light and a reference light in a unit of a hologram page, the method comprising steps of:
generating reference light for obtaining a reproduced image according to the recorded information on the hologram recording medium and DC light having uniform intensity and phase by subjecting light from the light source to spatial light modulation, and irradiating the hologram recording medium with both the reference light and the DC light and with only the DC light;
performing light-reception for the DC light and the reproduced image obtained from the hologram recording medium caused by the irradiation of both the reference light and the DC light, and performing light-reception for the DC light obtained through the hologram recording medium caused by the irradiation of only the DC light; and
calculating a difference between an image signal obtained based on the light-reception result of the reproduced image and the DC light by the light receiving process and an image signal obtained based on the light-reception result of only the DC light by the light receiving process.
